(19) United States
(12) Patent Application Publication
(10) Pub. No.: US 2025/0089726 A1
(43) Pub. Date: Mar. 20, 2025

(54) BOTANICAL BASED BIO-STIMULANT, BIO-ACARICIDAL COMPOSITIONS

(71) Applicant: KAY BEE BIO ORGANICS PVT LTD., Maharashtra (IN)

(72) Inventors: Sachin Babanrao YADAV, Maharashtra (IN); Tejas Pandurang JADHAV, Maharashtra (IN); Ashant Hanumant SABLE, Maharashtra (IN)

(21) Appl. No.: 18/507,629

(22) Filed: Nov. 13, 2023

(30) Foreign Application Priority Data
Sep. 18, 2023 (IN) 202321062645

(51) Int. Cl. A01N 65/20; A01N 25/04; A01N 65/10; A01N 65/12; A01N 65/18; A01N 65/22; A01N 65/24; A01N 65/26; A01N 65/28; A01N 65/36; A01N 65/48; A01P 7/02; A01P 21/00

(52) U.S. Cl. CPC A01N 65/20; A01N 25/04; A01N 65/08; A01N 65/10; A01N 65/12; A01N 65/18; A01N 65/22; A01N 65/24; A01N 65/26; A01N 65/28; A01N 65/36; A01N 65/40; A01N 65/42; A01N 65/48; A01P 7/02; A01P 21/00

(57) ABSTRACT

Disclosed herein is a synergistic botanical based bio-stimulant, bio-acaricide composition for controlling pests, increasing plant growth and crop yield by improving plant physiological process like photosynthesis and other essential metabolic process in plants/crops that is cost effective and environment friendly. Disclosed herein also is a process for preparation of said composition.

### CROSS-REFERENCE TO RELATED APPLICATIONS

The present application claims priority to Indian Patent Application number 202321062645 filed Sep. 18, 2023. The aforementioned application is hereby incorporated by reference in its entirety.

### TECHNICAL FIELD OF THE INVENTION

The present invention relates to synergistic botanical based bio-stimulant, bio-acaricidal compositions for controlling pests, increasing plant growth and crop yield by improving plant physiological process like photosynthesis and other essential metabolic process in plants/crops that is cost effective and environment friendly. The present invention also relates to process for preparation of said composition.

### BACKGROUND OF THE INVENTION

Agricultural and horticultural crops are attacked by various pests every year, the most important of which are insects, mites, nematodes and gastropod molluscs. They can adversely affect agricultural production and the natural environment. They can cause problems by damaging crops and food production, infesting livestock, and causing nuisance and health hazards to humans. The damage is caused both by direct damage to plants and by indirect effects of the fungal, bacterial or viral infections they transmit.

Major agriculture pests such as several species of ticks and mites can have disastrous effects on agriculture. There are hundreds of different species of mites, which are tiny arthropods that belong to the Tetranychidae family and are classified as Arachnids. Species of mites include Tetranychus urticae, Tetranychus cinnabarinus, Panonychus ulmi, and Panonychus citri, go by the common name “red or yellow mites”. Controlling red and yellow mite infestations on crops is crucial because, if left unchecked, they will have disastrous effects. Ticks and mites are important vectors of disease-causing pathogens in humans, wildlife and domestic animals and wreak havoc on agricultural products all over the world.

Chemical pesticides such as acaricides are used to kill pests such as ticks and mites. Acaricides include chlorinated hydrocarbons (e.g., dichlorodiphenyltrichloroethane; DDT), organophosphorous compounds (e.g., Diazinon), carbamates (e.g., carbaryl), pyrethroids (e.g., permethrin, flumethrin), formamidines, and avermectins. The pyrethroids are one of the most effective pesticides used for tick control.

Acaricides are effective in controlling or killing crop pests. However, with repeated application, pests develop tolerance and resistance to these chemical pesticides. Ticks have been found to be resistant to cyclodiene insecticides, chlorinated hydrocarbons, organophosphorus insecticides, and pyrethroid insecticides. They also cause a number of environmental problems, such as pesticide residue and pest resurgence. The use of chemical acaricides to control pests results in toxic chemicals being released into the environment, which are hazardous to both humans and the environment. Furthermore, these synthetic chemicals can frequently persist in the environment indefinitely. However, these chemical pesticides are widely used to maximize crop productivity, resulting in negative environmental effects that are harmful to humans and other animals.

In addition to these, chemical pesticides are the main cause of wide range toxicity to humans, reflecting in an increase in the number of cancer cases globally. Along with people paying attention to environmental and health issues on a daily basis, using safer bioinsecticides on crops has become a top priority to reduce the use of chemical pesticides.

Bio-pesticides are safer alternatives to chemical pesticides as they are efficient to use, have low toxicity, leave little residue, and are easy to decompose. They are safe against non-target organisms, and do not disrupt natural ecological defense systems.

The use of botanical based acaricides can effectively reduce chemical based acaricides consumption; therefore, the research and development of botanical pesticides that use plant extracts and chemical pesticides in combination has become a study hotspot of Pesticide Science in recent years.

CN102204555 discloses an insecticidal and acaricidal compound composition, comprising effective ingredients of a biopesticide lepimectin and bifenazate, and a weight ratio of the former to the latter is 0.1-50:80-1. It can be used for controlling damages caused by mites, insects with piercing-sucking mouthparts in fruit trees, crops and vegetables.

EP1301079A2 discloses botanical acaricides for controlling plant-infesting acari with plant extracts providing the advantages of minimal development of resistance thereto, minimal toxicity to mammals, minimal residual activity and environmental compatibility.

A need exists in the art to provide improved Bio-acaricidal compositions that reduce the use of synthetic chemical compounds, are environmentally friendly, and are safe for agriculture and humans.

Hence, the present inventors, with an aim to control the agricultural pests and improve plant growth and crop yield have come up with a synergistic botanical based bio-acaricidal composition which is eco friendly, relatively inexpensive, bio-degradable, residue free, safe for agriculture and humans and minimizes the risk of resistance development.

### OBJECT OF THE INVENTION

It is an object of the present invention to provide botanical based bio-stimulant, bio-acaricides from standardized, concentrated plant extracts or purified plant marker compounds thereby controlling the plant pests/insects and protects agriculture, horticulture, olericulture and floricultural crops.

It is another object of the present invention to provide a process for preparation of said bio-acaricidal composition.

### SUMMARY OF THE INVENTION

In an aspect, the present invention provides plant based bio-stimulant, bio-acaricidal composition comprising a combination of standardised enriched plant extract and purified phyto ingredient with a synergistic biological action that efficiently controls a wide range of pests that cause crop destruction.

In a main aspect, the present invention provides a synergistic botanical based bio-stimulant, bio-acaricidal composition for controlling pests, comprising:
i. Cinnamomum cassia extract or Enriched and Purified extract of Cinnamomum cassia or Purified Phyto ingredients or marker compounds such as Cinnamic aldehyde, catechin, epicatechin, quercitrin, protocatechuic acid and cinnamic acid extracted from said botanical source at a concentration in a range of 0.001-35%, more preferably 0.001-15%;
ii. Piper nigrum extract or Enriched and Purified extract of Piper nigrum or Purified Phyto ingredients or marker compounds) Piperine, amides, piperidine and pyrrolidines extracted from said botanical source at a concentration in a range of 0.001-35%, more preferably 0.001-10%;
iii. Syzygium aromaticum extract or Enriched and Purified extract of Syzygium aromaticum or Purified Phyto ingredients or marker compounds such as Eugenyl acetate, eugenol, and β-caryophyllene extracted from said botanical source at a concentration in a range of 0.001-45%, more preferably 0.001-8%;
iv. Allium sativum extract or enriched and purified extract of Allium sativum or Purified Phyto ingredients or marker compounds such as alliin, allicin and quercetin extracted from said botanical source at a concentration in a range of 0.001-45%, more preferably 0.05-13%;
v. Zingiber officinale extract or Enriched and Purified extract of Zingiber officinale or Purified Phyto ingredients or marker compounds such as gingerols, shogaols, and paradols extracted from said botanical source at a concentration in a range between 0.001-45%; more preferably 0.1-15%;
vi. Pongamia pinnata extract or Enriched and Purified extract of Pongamia pinnata or Purified Phyto ingredients or marker compounds such as karanjin, glabrin, and kanjone extracted from said botanical source at a concentration in a range of 0.001-45%, more preferably 2-20%;
vii. Anethum graveolens extract or Enriched and Purified extract of Anethum graveolens or Purified Phyto ingredients or marker compounds such as alkaloids, flavonoids, tannins and saponins extracted from said botanical source at a concentration in a range of 0.001-45%, more preferably 2.5-20%;
viii. Citrus sinensis extract or Enriched and Purified extract of Citrus sinensis or Purified Phyto ingredients or marker compounds such as limonene, γ-terpinene, β-pinene, linalool, sabinene, myrcene, α-terpineol, and α-pinene extracted from said botanical source at a concentration in a range of 0.001-45%, more preferably 1-22%;
ix. Melaleuca alternifolia extract or Enriched and Purified extract of Melaleuca alternifolia or Purified Phyto ingredients or marker compounds such as terpinen-4-ol, γ-terpinene, α-terpinene, α-pinene, 1,8 cineole and linalool extracted from said botanical source at a concentration in a range of 0.001-45%, more preferably 1.5-10%;
x. Cinnamomum camphora extract or Enriched and Purified extract of Cinnamomum camphora or Purified Phyto ingredients or marker compounds such as linalool, 1,8-cineole, α-terpineol, and camphor extracted from said botanical source at a concentration in a range of 0.001-45%, more preferably 0.05-15%;
xi. Ricinus communis extract or Enriched and Purified extract of Ricinus communis or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source at a concentration in a range of 0.001-45%, more preferably 2.5-20%;
xii. Sesamum indica extract or Enriched and Purified extract of Sesamum indica or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source at a concentration in a range of 0.001-55%, more preferably 15-40%;
xiii. Brassica napus extract or Enriched and Purified extract of Brassica napus or Purified Phyto ingredients or marker compounds such as polyphenols, phenolic acids, flavonoids, carotenoids (zeaxanthin, lutein, β-carotene), brassinolides alkaloids, tannins and saponins extracted from said botanical source at a concentration in a range of 0.001-55%, more preferably 1-12%;
xiv. Parthenium hysterophorus extract or Enriched and Purified extract of Parthenium hysterophorus or Purified Phyto ingredients or marker compounds such as sesquiterpene lactones, parthenin, quercelagetin, p-hydroxybenzene, chlorogenic acids and ferulic acids extracted from said botanical source at a concentration in a range of 0.001-55%, more preferably 1-15%;
xv. Rosmarinus officinalis extract or Enriched and Purified extract of Rosmarinus officinalis or Purified Phyto ingredients or marker compounds such as sesquiterpene lactones, parthenin, quercelagetin, p-hydroxybenzene, chlorogenic acids and ferulic acids extracted from said botanical source at a concentration in a range of 0.001-55%, more preferably 1.5-20%;
xvi. Acacia concinna extract or Enriched and Purified extract of Acacia concinna or Purified Phyto ingredients or marker compounds such as lupeol, spinasterol, acacic acid, lactone and natural sugars glucose extracted from said botanical source at a concentration in a range of 0.001-55%, more preferably 3-25%;
xvii. Mentha piperita extract or Enriched and Purified extract of Mentha piperita or Purified Phyto ingredients or marker compounds such as lupeol, spinasterol, acacic acid, lactone and natural sugars glucose extracted from said botanical source at a concentration in a range of 0.001-55%, more preferably 0.5-12%;
xviii. Acorus calamus extract or Enriched and Purified extract of Acorus calamus or Purified Phyto ingredients or marker compounds such as lupeol, spinasterol, acacic acid, lactone and natural sugars glucose extracted from said botanical source at a concentration in a range of 0.001-45%, more preferably 3.5-27%;
xix. Ocimum sanctum extract or Enriched and Purified extract of Ocimum sanctum or Purified Phyto ingredients or marker compounds such as oleanolic acid, rosmarinic acid, ursolic acid, eugenol, methyl eugenol, linalool, carvacrol, β elemene and β caryophyllene extracted from said botanical source at a concentration in a range of 0.001-55%, more preferably 0.5-12%;
xx. Lantana camara extract or Enriched and Purified extract of Lantana camara or Purified Phyto ingredients or marker compounds such as tannin, saponin, flavonoids, terpenoids, alkaloids, carbohydrate, anthroquinone and polyphenols extracted from said botanical source at a concentration in a range of 0.001-55%, more preferably 0.5-12%;
xxi. Piper longum extract or Enriched and Purified extract of Piper longum or Purified Phyto ingredients or marker compounds such as methyl piperine, Piperine piperlongumine, piperlonguminine, pipercide and piperidine extracted from said botanical source at a concentration in a range of 0.001-45%, more preferably 0.01-10%;
xxii. Annona squamosa extract or Enriched and Purified extract of Annona squamosa or Purified Phyto ingredients or marker compounds such as Annonacin, Squamocin, Annonin extracted from said botanical source at a concentration in a range of 0.001-45%, more preferably 0.01-12%;
xxiii. Azadirachta indica extract or Enriched and Purified extract of Azadirachta indica or Purified Phyto ingredients or marker compounds such as Annonacin, Squamocin, Annonin extracted from said botanical source at a concentration in a range of 0.001-45%, more preferably 1-15%;
xxiv. Cuminum cyminum extract or Enriched and Purified extract of Cuminum cyminum or Purified Phyto ingredients or marker compounds such as Cumin aldehyde, alkaloid, anthraquinone, saponin, tannin and steroid extracted from said botanical source at a concentration in a range of 0.001-45%, more preferably 0.5-12%;
xxv. organic emulsifier at a concentration in a range of 0.001-20%; preferably 10-12%;
xxvi. anionic emulsifier at a concentration in a range of 0.001-18%, preferably 7-10%;
xxvii. non-anionic emulsifiers at a concentration in a range of 0.001-20%, preferably 12-15%; and
xxviii. carrier oils at a concentration in a range 0.001-90%, preferably 60-65%.

In an aspect, the present composition may comprise an adjuvant at a concentration in the range of 0.001-25%, preferably 10-20%.

In an aspect, the synergistic botanical based bio-stimulant, bio-acaricidal composition of the present invention has a particle size in the range of 10-1000 nanometer, more specifically 1-100 nanometer.

In yet another aspect, the present invention provides a synergistic botanical based bio-stimulant, bio-acaricidal composition, comprising:
i. Brassica napus extract in the range of 0.001 to 35%;
ii. Piper nigrum extract in the range of 0.001 to 35%;
iii. Allium sativum extract in the range of 0.001 to 40%;
iv. Adjuvant in the range of 0.001 to 25%;
v. Acorus calamus extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%

In yet another aspect, the present invention provides a synergistic botanical based bio-stimulant, bio-acaricidal composition, comprising:
i. Lantana camara extract in the range of 0.001 to 35%;
ii. Piper nigrum extract in the range of 0.001 to 35%;
iii. Cinnamomum camphora extract in the range of 0.001 to 40%;
iv. Piper longum extract in the range of 0.001 to 25%;
v. Ocimum santum extract in the range of 0.001 to 35%;
vi. Citrus sinensis extract in the range of 0.001 to 25%;
vii. Gaur gum in the range of 0.001 to 18%;
viii. ethoxylated castor oil in the range of 0.001 to 20%; and
ix. Sesame oil in the range of 0.001 to 90%

In yet another aspect, the present invention provides a synergistic botanical based bio-stimulant, bio-acaricidal composition, comprising:
i. Cinnamomum cassia extract in the range of 0.001 to 35%;
ii. Piper nigrum extract in the range of 0.001 to 35%;
iii. Allium sativum extract in the range of 0.001 to 40%;
iv. Ocimum sanctum extract in the range of 0.001 to 25%;
v. Syzygium aromaticum extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%

In yet another aspect, the present invention provides a synergistic botanical based bio-stimulant, bio-acaricidal composition, comprising:
i. Rosmarinus officinalis extract in the range of 0.001 to 35%;
ii. Lantana camara extract in the range of 0.001 to 35%;
iii. Annona squamosa extract in the range of 0.001 to 40%;
iv. Azadirachta indica extract in the range of 0.001 to 25%;
v. Pongamia pinnata extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%

In yet another aspect, the present invention provides a synergistic botanical based bio-stimulant, bio-acaricidal composition, comprising:
i. Syzygium aromaticum extract in the range of 0.001 to 35%;
ii. Piper nigrum extract in the range of 0.001 to 35%;
iii. Allium sativum extract in the range of 0.001 to 40%;
iv. Zingiber officinale extract in the range of 0.001 to 35%;
v. Cinnamomum cassia extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%

In yet another aspect, the present invention provides a synergistic botanical based bio-stimulant, bio-acaricidal composition, comprising:
i. Cinnamomum cassia extract in the range of 0.001 to 35%;
ii. Citrus sinensis extract in the range of 0.001 to 35%;
iii. Allium sativum extract in the range of 0.001 to 40%;
iv. Melaleuca alternifolia extract in the range of 0.001 to 25%;
v. Cuminum cyminum extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%

In yet another aspect, the present invention provides a process for preparation of the synergistic botanical based bio-stimulant, bio-acaricidal composition, comprising:
a. Extracting 0.001-35% of Cinnamomum cassia or purified phyto ingredients or marker compounds such as Cinnamic aldehyde, catechin, epicatechin, quercitrin, protocatechuic acid and cinnamic acid extracted from said botanical source; 0.001-35% of Piper nigrum or Purified Phyto ingredients or marker compounds such as Piperine, amides, piperidine and pyrrolidines extracted from said botanical source; 0.001-45% of Syzygium aromaticum or Purified Phyto ingredients or marker compounds such as Eugenyl acetate, eugenol, and β-caryophyllene extracted from said botanical source; 0.001-45% of Allium sativum or Purified Phyto ingredients or marker compounds such as alliin, allicin and quercetin extracted from said botanical source; 0.001-45% of Zingiber officinale or Purified Phyto ingredients or marker compounds such as gingerols, shogaols, and paradols extracted from said botanical source; 0.001-45% of Pongamia pinnata or Purified Phyto ingredients or marker compounds such as karanjin, glabrin, and kanjone extracted from said botanical source; 0.001-45% of Anethum graveolens or Purified Phyto ingredients or marker compounds such as alkaloids, flavonoids, tannins and saponins extracted from said botanical source; 0.001-45% of Citrus sinensis Purified Phyto ingredients or marker compounds such as limonene, γ-terpinene, β-pinene, linalool, sabinene, myrcene, α-terpineol, and α-pinene extracted from said botanical source; 0.001-45% of Melaleuca alternifolia or Purified Phyto ingredients or marker compounds such as terpinen-4-ol, γ-terpinene, α-terpinene, α-pinene, 1,8 cineole and linalool extracted from said botanical source; 0.001-45% of Cinnamomum camphora or Purified Phyto ingredients or marker compounds such as linalool, 1,8-cineole, α-terpineol, and camphor extracted from said botanical source; 0.001-45% of Ricinus communis or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source; 0.001-55% of Sesamum indica or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source; 0.001-55% of Brassica napus or Purified Phyto ingredients or marker compounds such as polyphenols, phenolic acids, flavonoids, carotenoids (zeaxanthin, lutein, β-carotene), Brassinolide, alkaloids, tannins and saponins extracted from said botanical source; 0.001-55% of Parthenium hysterophorus or Purified Phyto ingredients or marker compounds such as sesquiterpene lactones, parthenin, quercelagetin, p-hydroxybenzene, chlorogenic acids and ferulic acids extracted from said botanical source; 0.001-55% of Rosmarinus officinalis or Purified Phyto ingredients or marker compounds such as sesquiterpene lactones, parthenin, quercelagetin, p-hydroxybenzene, chlorogenic acids and ferulic acids extracted from said botanical source; 0.001-55% of Acacia concinna or Purified Phyto ingredients or marker compounds such as lupeol, spinasterol, acacic acid, lactone and natural sugars glucose extracted from said botanical source; 0.001-55% of Mentha piperita or Purified Phyto ingredients or marker compounds such as lupeol, spinasterol, acacic acid, lactone and natural sugars glucose extracted from said botanical source; 0.001-45% of Acorus calamus or Purified Phyto ingredients or marker compounds such as methyl ethers, camphene, P-cymene, α-selinene, bgurjunene, β-cadinene, camphor, shyobunones, linalool and preisocalamendiol extracted from said botanical source; 0.001-55% of Ocimum sanctum or Purified Phyto ingredients or marker compounds such as oleanolic acid, rosmarinic acid, ursolic acid, eugenol, methyl eugenol, linalool, carvacrol, β elemene and β caryophyllene extracted from said botanical source; 0.001-55% of Lantana camara or Purified Phyto ingredients or marker compounds such as tannin, saponin, flavonoids, terpenoids, alkaloids, carbohydrate, anthroquinone and polyphenols extracted from said botanical source; 0.001-45% of Piper longum or Purified Phyto ingredients or marker compounds such as methyl piperine, Piperine piperlongumine, piperlonguminine, pipercide and piperidine extracted from said botanical source; 0.001-45% of Annona squamosa or Purified Phyto ingredients or marker compounds such as Annonacin, Squamocin, Annonin extracted from botanical source; 0.001-45% of Azadirachta indica or Purified Phyto ingredients or marker compounds such as Annonacin, Squamocin, Annonin extracted from said botanical source; 0.001-45% of Cuminum cyminum or Purified Phyto ingredients or marker compounds such as Cumin aldehyde, alkaloid, anthraquinone, saponin, tannin and steroid extracted from said botanical source;
b. optionally mixing the ingredients of step (a) at given proportion with 0.001-25% adjuvant;
c. mixing the mixture obtained in step (b) at given proportion along with 0.001-20% of organic emulsifier, 0.01-5% of anionic and 0.01-8% of non-anionic emulsifiers;
d. blending the mixture obtained in step (c) with 0.001-90% of carrier oils; more specifically 25-75%;
e. stirring the mixture obtained in step (d) at 300-1000 RPM more specifically at 350-750 RPM at 25-55° C. in closed mixing vessel for continued stirring followed by homogenizing the mix with the homogenizer fitted towards the bottom of vessel and with the speed of 3700˜27000 rpm to reduce the particle size;
f. passing the homogenized mixture obtained in step (e) through in line shear pump with 1800 RPM to 5800 RPM to reduce particle size to obtain the nano emulsion with particle size ranging from 10 to 1000 nano meter;
g. passing the mixture obtained in step (f) through High-pressure homogenization to reduce the particle size below 100 nano meters;
h. passing the mixture obtained in step (g) through sparkler filter having seven layers of membrane filters with pore size less than 1-2 micron to achieve desired filtration; and
i. recovering the final product.

The composition of the present invention is useful for controlling pests and improving yield of crop plants.

### BRIEF DESCRIPTION OF THE DRAWINGS

FIG. 1: Effect of Bio-stimulants on Yield of Orange

FIG. 2: Effect of Bio-stimulants on Seed Yield of Soybean

FIG. 3: Effect of Bio-stimulants on Fruit Yield of Tomato

FIG. 4: Percentage reduction in Mites population and Percentage increase in yield in Citrus

FIG. 5: Percentage reduction in Mites population and Percentage increase in yield in Rose

FIG. 6: Percentage reduction in Mites population and Percentage increase in yield in Tomato

FIG. 7: Percentage Mortality of Red mite population in Citrus

FIG. 8: Percentage Mortality of Red mite population in Rose

FIG. 9: Percentage Mortality of Red mite population in Tomato

### DETAILED DESCRIPTION OF THE INVENTION

The invention will now be described in detail in connection with certain preferred and optional embodiments, so that various aspects thereof may be more fully understood and appreciated.

In an embodiment, the present invention relates to a synergistic botanical based bio-stimulant, bio-acaricidal composition for controlling pests, comprising:
i. Cinnamomum cassia extract or Enriched and Purified extract of Cinnamomum cassia or Purified Phyto ingredients or marker compounds such as Cinnamic aldehyde, catechin, epicatechin, quercitrin, protocatechuic acid and cinnamic acid extracted from said botanical source at a concentration in a range of 0.001-35%, more preferably 0.001-15%;
ii. Piper nigrum extract or Enriched and Purified extract of Piper nigrum or Purified Phyto ingredients or marker compounds) Piperine, amides, piperidine and pyrrolidines extracted from said botanical source at a concentration in a range of 0.001-35%, more preferably 0.001-10%;
iii. Syzygium aromaticum extract or Enriched and Purified extract of Syzygium aromaticum or Purified Phyto ingredients or marker compounds such as Eugenyl acetate, eugenol, and β-caryophyllene extracted from said botanical source at a concentration in a range of 0.001-45%, more preferably 0.001-8%;
iv. Allium sativum extract or enriched and purified extract of Allium sativum or Purified Phyto ingredients or marker compounds such as alliin, allicin and quercetin extracted from said botanical source at a concentration in a range of 0.001-45%, more preferably 0.05-13%;
v. Zingiber officinale extract or Enriched and Purified extract of Zingiber officinale or Purified Phyto ingredients or marker compounds such as gingerols, shogaols, and paradols extracted from said botanical source at a concentration in a range of 0.001-45%; more preferably 0.1-15%;
vi. Pongamia pinnata extract or Enriched and Purified extract of Pongamia pinnata or Purified Phyto ingredients or marker compounds such as karanjin, glabrin, and kanjone extracted from said botanical source at a concentration in a range of 0.001-45%, more preferably 2-20%;
vii. Anethum graveolens extract or Enriched and Purified extract of Anethum graveolens or Purified Phyto ingredients or marker compounds such as alkaloids, flavonoids, tannins and saponins extracted from said botanical source at a concentration in a range of 0.001-45%, more preferably 2.5-20%;
viii. Citrus sinensis extract or Enriched and Purified extract of Citrus sinensis or Purified Phyto ingredients or marker compounds such as limonene, γ-terpinene, β-pinene, linalool, sabinene, myrcene, α-terpineol, and α-pinene extracted from said botanical source at a concentration in a range of 0.001-45%, more preferably 1.5-10%;
ix. Melaleuca alternifolia extract or Enriched and Purified extract of Melaleuca alternifolia or Purified Phyto ingredients or marker compounds such as terpinen-4-ol, γ-terpinene, α-terpinene, α-pinene, 1,8 cineole and linalool extracted from said botanical source at a concentration in a range of 0.001-45%, more preferably 1.5-10%;
x. Cinnamomum camphora extract or Enriched and Purified extract of Cinnamomum camphora or Purified Phyto ingredients or marker compounds such as linalool, 1,8-cineole, α-terpineol, and camphor extracted from said botanical source at a concentration in a range of 0.001-45%, more preferably 0.05-15%;
xi. Ricinus communis extract or Enriched and Purified extract of Ricinus communis or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source at a concentration in a range of 0.001-45%, more preferably 2.5-20%;
xii Sesamum indica extract or Enriched and Purified extract of Sesamum indica or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source at a concentration in a range of 0.001-55%, more preferably 15-40%;
xiii. Brassica napus extract or Enriched and Purified extract of Brassica napus or Purified Phyto ingredients or marker compounds such as polyphenols, phenolic acids, flavonoids, carotenoids (zeaxanthin, lutein, β-carotene), brassinolides, alkaloids, tannins and saponins extracted from said botanical source at a concentration in a range of 0.001-55%, more preferably 1-12%;
xiv. Parthenium hysterophorus extract or Enriched and Purified extract of Parthenium hysterophorus or Purified Phyto ingredients or marker compounds such as sesquiterpene lactones, parthenin, quercelagetin, p-hydroxybenzene, chlorogenic acids and ferulic acids extracted from said botanical source at a concentration in a range of 0.001-55%, more preferably 1-15%;
xv. Rosmarinus officinalis extract or Enriched and Purified extract of Rosmarinus officinalis or Purified Phyto ingredients or marker compounds such as sesquiterpene lactones, parthenin, quercelagetin, p-hydroxybenzene, chlorogenic acids and ferulic acids extracted from said botanical source at a concentration in a range of 0.001-55%, more preferably 1.5-20%;
xvi. Acacia concinna extract or Enriched and Purified extract of Acacia concinna or Purified Phyto ingredients or marker compounds such as lupeol, spinasterol, acacic acid, lactone and natural sugars glucose extracted from said botanical source at a concentration in a range of 0.001-55%, more preferably 3-25%;
xvii. Mentha piperita extract or Enriched and Purified extract of Mentha piperita or Purified Phyto ingredients or marker compounds such as lupeol, spinasterol, acacic acid, lactone and natural sugars glucose extracted from said botanical source at a concentration in a range of 0.001-55%, more preferably 0.5-12%;
xviii. Acorus calamus extract or Enriched and Purified extract of Acorus calamus or Purified Phyto ingredients or marker compounds such as lupeol, spinasterol, acacic acid, lactone and natural sugars glucose extracted from said botanical source at a concentration in a range of 0.001-45%, more preferably 3.5-27%;
xix. Ocimum sanctum extract or Enriched and Purified extract of Ocimum sanctum or Purified Phyto ingredients or marker compounds such as oleanolic acid, rosmarinic acid, ursolic acid, eugenol, methyl eugenol, linalool, carvacrol, β elemene and β caryophyllene extracted from said botanical source at a concentration in a range of 0.001-55%, more preferably 0.5-12%;
xx. Lantana camara extract or Enriched and Purified extract of Lantana camara or Purified Phyto ingredients or marker compounds such as tannin, saponin, flavonoids, terpenoids, alkaloids, carbohydrate, anthroquinone and polyphenols extracted from said botanical source at a concentration in a range of 0.001-55%, more preferably 0.5-12%;
xxi. Piper longum extract or Enriched and Purified extract of Piper longum or Purified Phyto ingredients or marker compounds such as methyl piperine, Piperine piperlongumine, piperlonguminine, pipercide and piperidine extracted from said botanical source at a concentration in a range of 0.001-45%, more preferably 0.01-10%;
xxii. Annona squamosa extract or Enriched and Purified extract of Annona squamosa or Purified Phyto ingredients or marker compounds such as Annonacin, Squamocin, Annonin extracted from said botanical source at a concentration in a range of 0.001-45%, more preferably 0.01-12%;
xxiii. Azadirachta indica extract or Enriched and Purified extract of Azadirachta indica or Purified Phyto ingredients or marker compounds such as Annonacin, Squamocin, Annonin extracted from said botanical source at a concentration in a range of 0.001-45%, more preferably 1-15%; and
xxiv. Cuminum cyminum extract or Enriched and Purified extract of Cuminum cyminum or Purified Phyto ingredients or marker compounds such as Cumin aldehyde, alkaloid, anthraquinone, saponin, tannin and steroid extracted from said botanical source at a concentration in a range of 0.001-45%, more preferably 1-12%;
xxv. organic emulsifier at a concentration in a range of 0.001-20%, preferably 10-12%;
xxvi. anionic emulsifier at a concentration in a range of 0.001-18%, preferably 7-10%;
xxvii. non-anionic emulsifiers at a concentration in a range of 0.001-20%, preferably 12-15%; and
xxviii. carrier oils at a concentration in a range 0.001-90%, preferably 60-65%.

In an embodiment, the present composition may contain an adjuvant at a concentration in the range of 0.001-25%, preferably 10-20%.

In an embodiment, the synergistic botanical based bio-stimulant, bio-acaricidal composition of the present invention has a particle size in the range of 10-1000 nanometer, more specifically 1-100 nanometer.

In another embodiment, the organic emulsifier include but not limited to rice bran wax, cetearyl glucoside, Aloe vera extract, plant saponins, aqueous extract of Indian soapberry (Sapindus mukorassi), aqueous extract of Acacia concinna, hydrolyzed coconut oil, bee wax, gaur gum and the like.

In another embodiment, the anionic and non-anionic emulsifier include but not limited poly sorbate 20, poly sorbate 60, poly sorbate 80, Lecithin, soy lecithin, sodium phosphates, monoglycerides, diglycerides, sodium stearoyl lactylate, glyceryl oleate, ethoxylated oleate, ethoxylated soybean oil, ethoxylated castor oil and the like.

In another embodiment, the carrier oils are selected from the group comprising seed oil of Anethum graveolens, Pongamaia pinnata oil, neem oil, castor oil, fish oil, sesame oil, mustard oil, canola oil, water and the like.

In another embodiment, the synergistic botanical based bio-stimulant, bio-acaricidal composition of the present invention comprising combination of standardised enriched botanical extract and purified phyto ingredient with a synergistic biological action that efficiently controls a wide range of pests that cause crop destruction by taking direct action on them.

In another embodiment, the synergistic botanical based bio-stimulant, bio-acaricidal composition of the present invention include enriched and purified Phyto ingredients such as saponins, polyphenols, alkaloids, flavonoids, terpenoids, or secondary metabolites from botanicals which produce important synergic interactions in their biological activity. The combination of these ingredients has been found to have synergistic benefits and effects, despite the fact that each of these ingredients has unique qualities and properties.

In yet another embodiment, the present invention provides a synergistic botanical based bio-stimulant, bio-acaricidal composition, comprising:
i. Brassica napus extract in the range of 0.001 to 35%;
ii. Piper nigrum extract in the range of 0.001 to 35%;
iii. Allium sativum extract in the range of 0.001 to 40%;
iv. Adjuvant in the range of 0.001 to 25%;
v. Acorus calamus extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%

In yet another embodiment, the present invention provides a synergistic botanical based bio-stimulant, bio-acaricidal composition, comprising:
i. Lantana camara extract in the range of 0.001 to 35%;
ii. Piper nigrum extract in the range of 0.001 to 35%;
iii. Cinnamomum camphora extract in the range of 0.001 to 40%;
iv. Piper longum extract in the range of 0.001 to 25%;
v. Ocimum santum extract in the range of 0.001 to 35%;
vi. Citrus sinensis extract in the range of 0.001 to 25%;
vii. Gaur gum in the range of 0.001 to 18%;
viii. ethoxylated castor oil in the range of 0.001 to 20%; and
ix. Sesame oil in the range of 0.001 to 90%

In yet another embodiment, the present invention provides a synergistic botanical based bio-stimulant, bio-acaricidal composition, comprising:
ix. Cinnamomum cassia extract in the range of 0.001 to 35%;
x. Piper nigrum extract in the range of 0.001 to 35%;
xi. Allium sativum extract in the range of 0.001 to 40%;
xii. Ocimum sanctum extract in the range of 0.001 to 25%;
xiii. Syzygium aromaticum extract in the range of 0.001 to 35%;
xiv. Gaur gum in the range of 0.001 to 18%;
xv. ethoxylated castor oil in the range of 0.001 to 20%; and
xvi. Canola oil in the range of 0.001 to 90%

In yet another embodiment, the present invention provides a synergistic bio-stimulant, bio-acaricidal composition, comprising:
ix. Rosmarinus officinalis extract in the range of 0.001 to 35%;
x. Lantana camara extract in the range of 0.001 to 35%;
xi. Annona squamosa extract in the range of 0.001 to 40%;
xii. Azadirachta indica extract in the range of 0.001 to 25%;
xiii. Pongamia pinnata extract in the range of 0.001 to 35%;
xiv. Gaur gum in the range of 0.001 to 18%;
xv. ethoxylated castor oil in the range of 0.001 to 20%; and
xvi. Canola oil in the range of 0.001 to 90%

In yet another embodiment, the present invention provides a synergistic botanical based bio-stimulant, bio-acaricidal composition, comprising:
ix. Syzygium aromaticum extract in the range of 0.001 to 35%;
x. Piper nigrum extract in the range of 0.001 to 35%;
xi. Allium sativum extract in the range of 0.001 to 40%;
xii. Zingiber officinale extract in the range of 0.001 to 35%;
xiii. Cinnamomum cassia extract in the range of 0.001 to 35%;
xiv. Gaur gum in the range of 0.001 to 18%;
xv. ethoxylated castor oil in the range of 0.001 to 20%; and
xvi. Canola oil in the range of 0.001 to 90%

In yet another embodiment, the present invention provides a synergistic botanical based bio-stimulant, bio-acaricidal composition, comprising:
ix. Cinnamomum cassia extract in the range of 0.001 to 35%;
x. Citrus sinensis extract in the range of 0.001 to 35%;
xi. Allium sativum extract in the range of 0.001 to 40%;
xii. Melaleuca alternifolia extract in the range of 0.001 to 25%;
xiii. Cuminum cyminum extract in the range of 0.001 to 35%;
xiv. Gaur gum in the range of 0.001 to 18%;
xv. ethoxylated castor oil in the range of 0.001 to 20%; and
xvi. Canola oil in the range of 0.001 to 90%

The synergistic effects of each plant ingredient were tested in combination with other plant ingredients at a ratio of 1:1 and compared to their respective individual effects on targeted insects under in vitro conditions. A combination is said to be synergistic if its mortality percentage is higher than that of any individual ingredient, and it is not if its mortality percentage is lower.

In another embodiment, the synergistic botanical based bio-stimulant, bio-acaricidal composition of the present invention is prepared by using various standardised enriched botanical extract and purified phyto ingredient from different plants source which provide synergistic effect and effectively controls against major agriculture pests.

In yet another embodiment, the present invention provides a process for preparation of the synergistic botanical based bio-stimulant, bio-acaricidal composition, comprising:
a. Extracting 0.001-35% of Cinnamomum cassia or purified phyto ingredients or marker compounds such as Cinnamic aldehyde, catechin, epicatechin, quercitrin, protocatechuic acid and cinnamic acid extracted from said botanical source; 0.001-35% of Piper nigrum or Purified Phyto ingredients or marker compounds such as Piperine, amides, piperidine and pyrrolidines extracted from said botanical source; 0.001-45% of Syzygium aromaticum or Purified Phyto ingredients or marker compounds such as Eugenyl acetate, eugenol, and β-caryophyllene extracted from said botanical source; 0.001-45% of Allium sativum or Purified Phyto ingredients or marker compounds such as alliin, allicin and quercetin extracted from said botanical source; 0.001-45% of Zingiber officinale or Purified Phyto ingredients or marker compounds such as gingerols, shogaols, and paradols extracted from said botanical source; 0.001-45% of Pongamia pinnata or Purified Phyto ingredients or marker compounds such as karanjin, glabrin, and kanjone extracted from said botanical source; 0.001-45% of Anethum graveolens or Purified Phyto ingredients or marker compounds such as alkaloids, flavonoids, tannins and saponins extracted from said botanical source; 0.001-45% of Citrus sinensis Purified Phyto ingredients or marker compounds such as limonene, γ-terpinene, β-pinene, linalool, sabinene, myrcene, α-terpineol, and α-pinene extracted from said botanical source; 0.001-45% of Melaleuca alternifolia or Purified Phyto ingredients or marker compounds such as terpinen-4-ol, γ-terpinene, α-terpinene, α-pinene, 1,8 cincole and linalool extracted from said botanical source; 0.001-45% of Cinnamomum camphora or Purified Phyto ingredients or marker compounds such as linalool, 1,8-cineole, α-terpincol, and camphor extracted from said botanical source; 0.001-45% of Ricinus communis or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source; 0.001-55% of Sesamum indica or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source; 0.001-55% of Brassica napus or Purified Phyto ingredients or marker compounds such as polyphenols, phenolic acids, flavonoids, carotenoids (zeaxanthin, lutein, β-carotene), brassinolides alkaloids, tannins and saponins extracted from said botanical source; 0.001-55% of Parthenium hysterophorus or Purified Phyto ingredients or marker compounds such as sesquiterpene lactones, parthenin, quercelagetin, p-hydroxybenzene, chlorogenic acids and ferulic acids extracted from said botanical source; 0.001-55% of Rosmarinus officinalis or Purified Phyto ingredients or marker compounds such as sesquiterpene lactones, parthenin, quercelagetin, p-hydroxybenzene, chlorogenic acids and ferulic acids extracted from said botanical source; 0.001-55% of Acacia concinna or Purified Phyto ingredients or marker compounds such as lupeol, spinasterol, acacic acid, lactone and natural sugars glucose extracted from said botanical source; 0.001-55% of Mentha piperita or Purified Phyto ingredients or marker compounds such as lupeol, spinasterol, acacic acid, lactone and natural sugars glucose extracted from said botanical source; 0.001-45% of Acorus calamus or Purified Phyto ingredients or marker compounds such as methyl ethers, camphene, P-cymene, α-selinene, bgurjunene, β-cadinene, camphor, shyobunones, linalool and preisocalamendiol extracted from said botanical source; 0.001-55% of Ocimum sanctum or Purified Phyto ingredients or marker compounds such as oleanolic acid, rosmarinic acid, ursolic acid, eugenol, methyl eugenol, linalool, carvacrol, β elemene and β caryophyllene extracted from said botanical source; 0.001-55% of Lantana camara or Purified Phyto ingredients or marker compounds such as tannin, saponin, flavonoids, terpenoids, alkaloids, carbohydrate, anthroquinone and polyphenols extracted from said botanical source; 0.001-45% of Piper longum or Purified Phyto ingredients or marker compounds such as methyl piperine, Piperine piperlongumine, piperlonguminine, pipercide and piperidine extracted from said botanical source; 0.001-45% of Annona squamosa or Purified Phyto ingredients or marker compounds such as Annonacin, Squamocin, Annonin extracted from said botanical source; 0.001-45% of Azadirachta indica or Purified Phyto ingredients or marker compounds such as Annonacin, Squamocin, Annonin extracted from said botanical source; 0.001-45% of Cuminum cyminum or Purified Phyto ingredients or marker compounds such as Cumin aldehyde, alkaloid, anthraquinone, saponin, tannin and steroid extracted from said botanical source;
b. optionally mixing the ingredients of step (a) at given proportion with 0.001-25% adjuvant;
c. mixing the mixture obtained in step (b) at given proportion along with 0.001-20% of organic emulsifier, 0.01-5% of anionic and 0.01-8% % of non-anionic emulsifiers;
d. blending the mixture obtained in step (c) with 0.001-90% of carrier oils; more specifically 25-75%
e. stirring the mixture obtained in step (d) at 300-1000 RPM more specifically at 350-750 RPM at 25-55° C. in closed mixing vessel for continued stirring followed by homogenizing the mix with the homogenizer fitted towards the bottom of vessel and with the speed of 3700˜27000 rpm to reduce the particle size;
f. passing the homogenized mixture obtained in step (e) through in line shear pump with 1800 RPM to 5800 RPM to reduce particle size to obtain the nano emulsion with particle size ranging from 10 to 1000 nano meter;
g. passing the mixture obtained in step (f) through High-pressure homogenization to reduce the particle size below 100 nano meters;
h. passing the mixture obtained in step (g) through sparkler filter having seven layers of membrane filters with pore size less than 1-2 micron to achieve desired filtration; and
i. recovering the final product.

In an embodiment, the mixing vessel in step (e) made up of stainless steel 316 grade with outer jacket for maintaining temperature with a stirrer such as blade stirrer, propeller stirrer, turbine stirrer, anchor stirrer, universal stirrer and the like.

In another embodiment, the homogenization of step (e) is done under very high pressures, sheer, turbulence, acceleration and impact, to make the particles more stable and effective.

In another embodiment, the high-pressure homogenization of step (g) is done at speed of 4000 rpm to 10000 rpm and pressure max up to 4,200 bar (60,000 psi).

The process for producing the standardised and enriched extract and purified phyto ingredients, active ingredient, or marker compound is obtained by performing extraction using a variety of processes, such as solvent, aqueous, steam distillation, or supercritical carbon dioxide extraction, wherein the solvent used is selected from ethanol, methanol, ethyl acetate, acetone, isopropyl alcohol chloroform, N-butanol, hexane or super critical carbon dioxide.

Further purification of Phyto ingredient is carried by using liquid liquid extraction, various chromatograph techniques like silica gel chromatography, ion exchange chromatography and other purification like precipitation and crystallisation to obtain highly pure form of Phyto ingredient or marker compound.

Instead of using individual standardized extract or purified phyto ingredients, which can be used separately or not separately, a holistic approach using extract and phyto ingredients from plants was used to control major group of red and yellow mites which can be disastrous if not controlled. The botanical extract used as ingredients in formulation are standardized and quantified as well as Phyto ingredient profile has been explored.

In an embodiment, the standardized botanical extract are blend with each other along with more than one and less than five emulsifiers, this blend is prepared at specific temperature ranging from 10° C. to 45° C. and stirring at specific RPM ranging from 50-800 RPM, particle size of formulation has been reduced to achieve nano range by using various modules like Filter press, shear pump, homogenizer and High pressure homogenization (pressure max up to 45,000 PSI) to obtain Nano formulation with average particle size range between 10-1000 nm.

In another embodiment, the extraction techniques include but not limited to hydrophilic extraction, super critical carbon dioxide extraction, steam distillation, solvent extraction and Soxhlet extraction.

In another embodiment, the adjuvants are selected from one or more silicone polyether, amine surfactant or amine surfactant ingredient, lecithin or lecithin, polyethylene oxide, polyethylene and the like, more preferably Silicone polyether and amine surfactant.

In another embodiment, the solvent used in the solvent extraction includes but not limited to alcohols, hydrocarbons, ketones, esters, ethers, and the like alone or in a combination thereof, more preferably alcohols like methanol, ethyl acetate and hexane.

In another embodiment, the enrichment and purification of the extract using various techniques include but not limited to liquid-liquid extraction base on polarity of phyto ingredient, column chromatography by using various medium and matrix, precipitation and crystallisation etc. to obtain purified phyto ingredients such as but not limited to 2-ethyl-1,3-dimethylbenzene, 2-(12-pentadecynyloxy) tetrahydro2H-pyran, 3-furanyl [2-hydroxy-4-methyl-2-(2-methylpropyl)cyclopentyl]-methanone, 2, 2-dideuterooctadecanal, hexadecanoic acid, Linoleic acid and the like, more preferably Liquid-liquid extraction and column chromatography.

In another embodiment, the organic emulsifier include but not limited to rice bran wax, cetearyl glucoside, Aloe vera extract, plant saponins, aqueous extract of Indian soapberry (Sapindus mukorassi), aqueous extract of Acacia concinna, hydrolyzed coconut oil, bee wax, gaur gum and the like.

In another embodiment, the anionic and non-anionic emulsifier include but not limited poly sorbate 20, poly sorbate 60, poly sorbate 80, Lecithin, soy lecithin, sodium phosphates, monoglycerides, diglycerides, sodium stearoyl lactylate, glyceryl oleate, ethoxylated oleate, ethoxylated soybean oil, ethoxylated castor oil and the like.

In another embodiment, the carrier oils are selected from the group comprising seed oil of Anethum graveolens, Pongamaia pinnata oil, neem oil, castor oil, fish oil, sesame oil, mustard oil, canola oil, water and the like.

In another embodiment, the synergistic bio-acaricidal composition of the present invention may be in the form of liquid, paste, powder or powder converted into granule or tablet form and the like, more preferably in liquid form.

The bio-acaricide composition of the present invention is evaluated by conducting bio efficacy tests in vitro and in vivo on a more precise group of pests. It is further evaluated to show bio stimulant activity in plants. Significant plant growth stimulant activity is observed with respect to height, girth, chlorophyll content, number of fruit and flower and yield.

In another embodiment, the synergistic bio-stimulant, bio-acaricidal composition of the present invention is effective against major agricultural pests such as sucking pests, spiders, ticks, mites including red or yellow mites such as Tetranychus urticae, Tetranychus cinnabarinus, Panonychus ulmi, and Panonychus citri and other pests that feed on plants and other living things.

In another embodiment, the synergistic bio-stimulant, bio-acaricidal composition of the present invention is provided at a concentration ranging between 0.5 to 2.0 ml/L.

In another embodiment, the present synergistic bio-stimulant, bio-acaricidal composition discloses dose dependent bio-stimulant, bio-acaricidal activity as demonstrated in the Table 9, 10 and 11 respectively.

In another embodiment, the synergistic bio-stimulant, bio-acaricidal composition of the present invention can be applied by sprinkler application, sprayer application or drip application. The composition may preferably be applied by sprayer application such as foliar sprays, sprays to be applied to plants shoots and the like.

In another embodiment, the synergistic bio-stimulant, bio-acaricidal composition of the present invention shows high specificity for the target pest, low toxicity for mammals and low environmental persistence. It attacks pests through contact, fumigant, and systematic action, and it is simple to use.

In another embodiment, the synergistic bio-stimulant, bio-acaricidal composition of the present invention exhibits synergism at specific concentration and thereby controls the plant pests and protects agriculture, horticulture, olericulture and floricultural crops.

In another embodiment, the synergistic bio-stimulant, bio-acaricidal composition of the present invention is useful for controlling plant pests and improving yield of crop plants.

In another embodiment, the synergistic bio-stimulant, bio-acaricidal composition of the present invention exhibits biostimulant activity and thereby improves plant growth and crop yield.

In another embodiment, the synergistic bio-stimulant, bio-acaricidal composition of the present invention are easily taken up by plants which significantly boost the plant growth with respect of height, growth, chlorophyll content, increase in flower and fruit number and subsequently the yield.

In another embodiment, the synergistic bio-stimulant, bio-acaricidal composition of the present invention is effective against broad group of pests within 48-72 hrs of application with low risk of resistance development.

In another embodiment, the synergistic bio-stimulant, bio-acaricidal composition of the present invention is effective at controlling pests within 48 hours of application, and growth stimulation activity is visible after 72 hours as demonstrated in Examples given below.

In an embodiment, the present invention discloses a method for controlling the pest and promoting the growth of the plants comprising applying the present bio-acaricidal composition to the plant or to diseased affected parts of the plant in an effective amount.

The bio-acaricidal composition of the present invention has multiple advantages/benefits such as—
1. The bio-acaricidal composition of the present invention helps in controlling agricultural pests such as sucking pests, spiders, ticks and mites.
2. The bio-acaricidal composition of the present invention have a holistic defence approach to control destructive pest, however the risk of resistance development is low as it is multi-ingredient product as well the product exhibits multi-mode action. Risk of resistance development is very high for synthetic chemical acaricide on repeated exposure.
3. The bio-acaricidal compositions of the present invention are easily degraded, show low toxicity and are relatively safe for humans and other animals.
4. It is eco friendly, relatively inexpensive, safe for agriculture and humans and minimizes the risk of resistance development.
5. It also helps in increasing plant growth and enhancing yield of the crops.
6. It is environmentally safe, biodegradable, residue-free and thus minimizes the chemical residue on our planet.

The following example, which includes preferred embodiments, will serve to illustrate the practice of this invention, it being understood that the particulars shown are by way of example and for purpose of illustrative discussion of preferred embodiments of the invention.

### EXAMPLES

### Example 1: Bio-Acaricidal Composition with Mode of Action

TABLE 1

| | | Different form of | Part | | | |
|---|---|---|---|---|---|---|
| | | botanical base Bio- | Percentage | | | |
| Sr. | Class of Bio- | pesticides used in | used in | Percent | Pesticidal | Mode of |
| No. | pesticides | formulation | formulation | Range | Properties | action |
| 1. | Cinnamomum | Cinnamomum | 7.0% | 0.001- | Acaricidal | Anti |
| | cassia | cassia extract | | 35% | activity | feeding |
| | | Enriched & | 3.0% | 0.001- | | Oviposition |
| | | Purified extract of | | 25% | | deterrence |
| | | Cinnamomum | | | | Disturb |
| | | cassia | | | | central |
| | | (Purified Phyto | 1.2% | 0.001- | | nervous |
| | | ingredients or | | 15% | | system |
| | | marker | | | | Affect egg |
| | | compounds) | | | | hatchability |
| | | Cinnamic | | | | |
| | | aldehyde, catechin, | | | | |
| | | epicatechin, | | | | |
| | | quercitrin, | | | | |
| | | protocatechuic acid | | | | |
| | | and cinnamic acid | | | | |
| 2. | Cuminum | Cuminum cyminum | 8.0% | 0.001- | Acaricidal | Interfere |
| | cyminum | extract | | 45% | activity | with |
| | | Enriched & | 4.8% | 0.001- | | protein |
| | | Purified extract of | | 30% | | synthesis |
| | | Cuminum cyminum | | | | Anti |
| | | (Purified Phyto | 2.0% | 0.001- | | feeding |
| | | ingredients or | | 20% | | Oviposition |
| | | marker | | | | deterrence |
| | | compounds) | | | | Disturb |
| | | Cumin aldehyde, | | | | central |
| | | alkaloid, | | | | nervous |
| | | anthraquinone, | | | | system |
| | | saponin, tannin and | | | | |
| | | steroid | | | | |
| 3. | Piper nigrum | Piper nigrum | 8.0% | 0.001- | Acaricidal | Inhibiting |
| | | extract | | 35% | activity | of proteins |
| | | Enriched & | 2.5% | 0.001- | | synthesis |
| | | Purified extract of | | 25% | | Anti |
| | | Piper nigrum | | | | feeding |
| | | (Purified Phyto | 1.5% | 0.001- | | |
| | | ingredients or | | 15% | | |
| | | marker | | | | |
| | | compounds) | | | | |
| | | Piperine, amides, | | | | |
| | | piperidine and | | | | |
| | | pyrrolidines | | | | |
| 4. | Piper longum | Piper longum | 5.0% | 0.001- | Acaricidal | Inhibiting |
| | | extract | | 45% | activity | of proteins |
| | | Enriched & | 2.5% | 0.001- | | synthesis |
| | | Purified extract of | | 30% | | Anti |
| | | Piper longum | | | | feeding |
| | | (Purified Phyto | 1.5% | 0.001- | | Disrupts |
| | | ingredients or | | 15% | | cell wall & |
| | | marker | | | | membrane |
| | | compounds) | | | | |
| | | methyl piperine, | | | | |
| | | Piperine | | | | |
| | | piperlongumine, | | | | |
| | | piperlonguminine, | | | | |
| | | pipercide and | | | | |
| | | piperidine | | | | |
| 5. | Syzygium | Syzygium | 5.5% | 0.001- | Acaricidal | Disrupts |
| | aromaticum | aromaticum extract | | 45% | activity | cell wall & |
| | | Enriched & | 3.5% | 0.001- | | membrane |
| | | Purified extract of | | 30% | | integrity |
| | | Syzygium | | | | Anti |
| | | aromaticum | | | | feeding |
| | | (Purified Phyto | 1.5% | 0.001- | | Oviposition |
| | | ingredients or | | 15% | | deterrence |
| | | marker | | | | Disturb |
| | | compounds) | | | | central |
| | | Eugenyl | | | | nervous |
| | | acetate, eugenol, | | | | system |
| | | and β- | | | | Affect egg |
| | | caryophyllene | | | | hatchability |
| 6. | Allium sativum | Allium sativum | 3.0% | 0.001- | Acaricidal | Interfere |
| | | extract | | 45% | activity | with |
| | | Enriched & | 1.5% | 0.001- | | protein |
| | | Purified extract of | | 30% | | synthesis |
| | | Allium sativum | | | | Anti |
| | | (Purified Phyto | 0.5% | 0.001- | | feeding |
| | | ingredients or | | 15% | | Oviposition |
| | | marker | | | | deterrence |
| | | compounds) | | | | Disturb |
| | | alliin, allicin and | | | | central |
| | | quercetin | | | | system |
| 7. | Zingiber | Zingiber officinale | 5.25% | 0.001- | Acaricidal | Anti |
| | officinale | extract | | 45% | activity | feeding |
| | | Enriched & | 2.5% | 0.001- | | Oviposition |
| | | Purified extract of | | 30% | | deterrence |
| | | Zingiber officinale | | | | Disturb |
| | | (Purified Phyto | 1.5% | 0.001- | | central |
| | | ingredients or | | 15% | | nervous |
| | | marker | | | | system |
| | | compounds) | | | | Affect egg |
| | | gingerols, shogaols, | | | | hatchability |
| | | and paradols | | | | |
| 8. | Pongamia | Pongamia pinnata | 12.5% | 0.001- | Acaricidal | Anti |
| | pinnata | extract | | 45% | activity | feeding |
| | | Enriched & | 5.5% | 0.001- | | Oviposition |
| | | Purified extract of | | 30% | | deterrence |
| | | Pongamia pinnata | | | | Disturb |
| | | (Purified Phyto | 2.5% | 0.001- | | central |
| | | ingredients or | | 15% | | nervous |
| | | marker | | | | system |
| | | compounds) | | | | Affect egg |
| | | karanjin, glabrin, | | | | hatchability |
| | | and kanjone | | | | |
| 9. | Anethum | Anethum | 5.0% | 0.001- | Acaricidal | Anti |
| | graveolens | graveolens extract | | 45% | activity | feeding |
| | | Enriched & | 3.5% | 0.001- | | Oviposition |
| | | Purified extract of | | 30% | | deterrence |
| | | Anethum | | | | Disturb |
| | | graveolens | | | | central |
| | | (Purified Phyto | 2.5% | 0.001- | | nervous |
| | | ingredients or | | 15% | | system |
| | | marker | | | | |
| | | compounds) | | | | |
| | | alkaloids, | | | | |
| | | flavonoids, tannins | | | | |
| | | and saponins | | | | |
| 10. | Citrus sinensis | Citrus sinensis | 7.0% | 0.001- | Acaricidal | Anti |
| | | extract | | 45% | activity | feeding |
| | | Enriched & | 3.8% | 0.001- | | Oviposition |
| | | Purified extract of | | 30% | | deterrence |
| | | Citrus sinensis | | | | Disturb |
| | | (Purified Phyto | 2.2% | 0.001- | | central |
| | | ingredients or | | 15% | | nervous |
| | | marker | | | | system |
| | | compounds) | | | | |
| | | limonene, γ- | | | | |
| | | terpinene, β-pinene, | | | | |
| | | linalool, sabinene, | | | | |
| | | myrcene, α- | | | | |
| | | terpineol, and α- | | | | |
| | | pinene. | | | | |
| 11. | Melaleuca | Melaleuca | 6.0% | 0.001- | Acaricidal | Anti |
| | alternifolia | alternifolia extract | | 45% | activity | feeding |
| | | Enriched & | 4.5% | 0.001- | | Interfere |
| | | Purified extract of | | 30% | | with |
| | | Melaleuca | | | | glucose |
| | | alternifolia | | | | uptake |
| | | (Purified Phyto | 2.5% | 0.001- | | |
| | | ingredients or | | 15% | | |
| | | marker | | | | |
| | | compounds) | | | | |
| | | terpinen-4-ol, γ- | | | | |
| | | terpinene, α- | | | | |
| | | terpinene, α-pinene, | | | | |
| | | 1,8 cineole and | | | | |
| | | linalool | | | | |
| 12. | Cinnamomum | Cinnamomum | 5.0% | 0.001- | Acaricidal | Anti |
| | camphora | camphora extract | | 45% | activity | feeding |
| | | Enriched & | 2.0% | 0.001- | | Oviposition |
| | | Purified extract of | | 30% | | deterrence |
| | | Cinnamomum | | | | central |
| | | camphora | | | | nervous |
| | | (Purified Phyto | 1.0% | 0.001- | | system |
| | | ingredients or | | 15% | | |
| | | marker | | | | |
| | | compounds) | | | | |
| | | linalool, 1,8- | | | | |
| | | cineole, α | | | | |
| | | terpineol, and | | | | |
| | | camphor | | | | |
| 13. | Acorus calamus | Acorus calamus | 10.0% | 0.001- | Acaricidal | Anti |
| | | extract | | 45% | activity | feeding |
| | | Enriched & | 7.5% | 0.001- | | Oviposition |
| | | Purified extract of | | 30% | | deterrence |
| | | Acorus calamus | | | | Disturb |
| | | (Purified Phyto | 4.5% | 0.001- | | central |
| | | ingredients or | | 15% | | nervous |
| | | marker | | | | system |
| | | compounds) | | | | |
| | | methyl ethers, | | | | |
| | | camphene, | | | | |
| | | P-cymene, | | | | |
| | | α-selinene, | | | | |
| | | bgurjunene, | | | | |
| | | β-cadinene, | | | | |
| | | camphor, | | | | |
| | | shyobunones, | | | | |
| | | linalool and | | | | |
| | | preisocalamendiol | | | | |
| 14. | Annona | Annona squamosa | 2.5% | 0.001- | Acaricidal | Anti |
| | squamosa | extract | | 45% | activity | feeding |
| | | Enriched & | 1.8% | 0.001- | | Oviposition |
| | | Purified extract of | | 30% | | deterrence |
| | | Annona squamosa | | | | Disturb |
| | | (Purified Phyto | 1.0% | 0.001- | | central |
| | | ingredients or | | 15% | | nervous |
| | | marker | | | | system |
| | | compounds) | | | | Affect egg |
| | | Annonacin, | | | | hatchability |
| | | Squamocin, | | | | |
| | | Annonin | | | | |
| 15. | Azadirachta | Azadirachta indica | 5.0% | 0.001- | Acaricidal | Anti |
| | indica | extract | | 45% | activity | feeding |
| | | Enriched & | 3.7% | 0.001- | | Oviposition |
| | | Purified extract of | | 30% | | deterrence |
| | | Azadirachta indica | | | | Disturb |
| | | (Purified Phyto | 1.5% | 0.001- | | central |
| | | ingredients or | | 15% | | nervous |
| | | marker | | | | system |
| | | compounds) | | | | Affect egg |
| | | Annonacin, | | | | hatchability |
| | | Squamocin, | | | | |
| | | Annonin | | | | |
| 16. | Ricinus | Ricinus communis | 10.0% | 0.001- | Acaricidal | Anti |
| | communis | extract | | 45% | activity | feeding |
| | | Enriched & | 5.3% | 0.001- | | Oviposition |
| | | Purified extract of | | 30% | | deterrence |
| | | Ricinus communis | | | | Disturb |
| | | (Purified Phyto | 2.5% | 0.001- | | central |
| | | ingredients or | | 15% | | nervous |
| | | marker | | | | system |
| | | compounds) | | | | Affect egg |
| | | kaempferol-3- | | | | hatchability |
| | | O and lupeol, β - | | | | |
| | | and α -amyrin, | | | | |
| | | quercetin, camphor, | | | | |
| | | ricin, epicatechin, | | | | |
| | | catechin, linoleic | | | | |
| | | acid and ricinoleic | | | | |
| | | acid | | | | |
| 17. | Sesamum indica | Sesamum indica | 35.0% | 0.001- | Acaricidal | Anti |
| | | extract | | 55% | activity | feeding |
| | | Enriched & | 10.0% | 0.001- | | Oviposition |
| | | Purified extract of | | 30% | | deterrence |
| | | Sesamum indica | | | | Disturb |
| | | (Purified Phyto | 5.6% | 0.001- | | central |
| | | ingredients or | | 15% | | nervous |
| | | marker | | | | system |
| | | compounds) | | | | Affect egg |
| | | kaempferol-3- | | | | hatchability |
| | | O and lupeol, β - | | | | |
| | | and a -amyrin, | | | | |
| | | quercetin, camphor, | | | | |
| | | ricin, epicatechin, | | | | |
| | | catechin, linoleic | | | | |
| | | acid and ricinoleic | | | | |
| | | acid | | | | |
| 18. | Brassica napus | Brassica napus | 8.0% | 0.001- | Acaricidal | Anti |
| | | extract | | 55% | activity | feeding |
| | | Enriched & | 4.0% | 0.001- | | Oviposition |
| | | Purified extract of | | 30% | | deterrence |
| | | Brassica napus | | | | Disturb |
| | | (Purified Phyto | 2.2% | 0.001- | | central |
| | | ingredients or | | 15% | | nervous |
| | | marker | | | | system |
| | | compounds) | | | | Plant |
| | | polyphenols, | | | | growth |
| | | phenolic acids, | | | | stimulation |
| | | flavonoids, | | | | |
| | | carotenoids | | | | |
| | | (zeaxanthin, lutein, | | | | |
| | | β-carotene), | | | | |
| | | Brassinolide, | | | | |
| | | alkaloids, tannins | | | | |
| | | and saponins, | | | | |
| 19. | Lantana | Lantana camara | 5.0% | 0.001- | Acaricidal | Anti |
| | camara | extract | | 55% | activity | feeding |
| | | Enriched & | 3.0% | 0.001- | | Oviposition |
| | | Purified extract of | | 30% | | deterrence |
| | | Lantana camara | | | | Disturb |
| | | (Purified Phyto | 1.3% | 0.001- | | central |
| | | ingredients or | | 15% | | nervous |
| | | marker | | | | system |
| | | compounds) | | | | Affect egg |
| | | tannin, saponin, | | | | hatchability |
| | | flavonoids, | | | | |
| | | terpenoids, | | | | |
| | | alkaloids, | | | | |
| | | carbohydrate, | | | | |
| | | anthroquinone and | | | | |
| | | polyphenols | | | | |
| 20. | Parthenium | Parthenium | 8.5% | 0.001- | Acaricidal | Anti |
| | hysterophorus | hysterophorus | | 55% | activity | feeding |
| | | extract | | | | Oviposition |
| | | Enriched & | 3.0% | 0.001- | | deterrence |
| | | Purified extract of | | 30% | | Disturb |
| | | Parthenium | | | | central |
| | | hysterophorus | | | | nervous |
| | | (Purified Phyto | 2.0% | 0.001- | | system |
| | | ingredients or | | 15% | | Affect egg |
| | | marker | | | | hatchability |
| | | compounds) | | | | |
| | | sesquiterpene | | | | |
| | | lactones, parthenin, | | | | |
| | | quercelagetin, p- | | | | |
| | | hydroxybenzene, | | | | |
| | | chlorogenic acids | | | | |
| | | and ferulic acids | | | | |
| 21. | Rosmarinus | Rosmarinus | 10.0% | 0.001- | Acaricidal | Anti |
| | officinalis | officinalis extract | | 55% | activity | feeding |
| | | Enriched & | 5.0% | 0.001- | | Oviposition |
| | | Purified extract of | | 30% | | deterrence |
| | | Rosmarinus | | | | Disturb |
| | | officinalis | | | | central |
| | | (Purified Phyto | 3.5% | 0.001- | | nervous |
| | | ingredients or | | 15% | | system |
| | | marker | | | | |
| | | compounds) | | | | |
| | | sesquiterpene | | | | |
| | | lactones, parthenin, | | | | |
| | | quercelagetin, p- | | | | |
| | | hydroxybenzene, | | | | |
| | | chlorogenic acids | | | | |
| | | and ferulic acids | | | | |
| 22 | Ocimum | Ocimum sanctum | 6.0% | 0.001- | Acaricidal | Interfere |
| | sanctum | extract | | 55% | activity | with |
| | | Enriched & | 4.5% | 0.001- | | protein |
| | | Purified extract of | | 30% | | synthesis |
| | | Ocimum sanctum | | | | Anti |
| | | (Purified Phyto | 2.5% | 0.001- | | feeding |
| | | ingredients or | | 15% | | Oviposition |
| | | marker | | | | deterrence |
| | | compounds) | | | | Disturb |
| | | oleanolic acid, | | | | central |
| | | rosmarinic acid, | | | | nervous |
| | | ursolic acid, | | | | system |
| | | eugenol, methyl | | | | |
| | | eugenol, linalool, | | | | |
| | | carvacrol, β | | | | |
| | | elemene and β | | | | |
| | | caryophyllene | | | | |
| 23. | Acacia | Acacia concinna | 13.0% | 0.001- | Acaricidal | Anti |
| | concinna | extract | | 55% | activity | feeding |
| | | Enriched & | 7.0% | 0.001- | | Oviposition |
| | | Purified extract of | | 30% | | deterrence |
| | | Acacia concinna | | | | Disturb |
| | | Purified Phyto | 5.0% | 0.001- | | central |
| | | ingredients or | | 15% | | nervous |
| | | marker | | | | system |
| | | compounds) | | | | |
| | | lupeol, spinasterol, | | | | |
| | | acacic acid, lactone | | | | |
| | | and natural sugars | | | | |
| | | glucose. | | | | |
| 24. | Mentha piperita | Mentha piperita | 7.0% | 0.001- | Acaricidal | Disrupts |
| | | extract | | 55% | activity | cell wall & |
| | | Enriched & | 4.2% | 0.001- | | membrane |
| | | Purified extract of | | 30% | | integrity |
| | | Mentha piperita | | | | Interfere |
| | | (Purified Phyto | 2.8% | 0.001- | | with |
| | | ingredients or | | 15% | | protein |
| | | marker | | | | synthesis |
| | | compounds) | | | | Anti |
| | | lupeol, spinasterol, | | | | feeding |
| | | acacic acid, lactone | | | | Oviposition |
| | | and natural sugars | | | | deterrence |
| | | glucose. | | | | Disturb |
| | | | | | | central |
| | | | | | | nervous |
| | | | | | | system |

### Example 2: Detail List of Ingredients Used in Bio-Acaricide

TABLE 2

| Sr. | | Common | | Active Ingredient (Marker |
|---|---|---|---|---|
| No. | Botanical Name | Name | Part Used | compound) |
| 1. | Cinnamomum | Cinnamomum | Bark | Cinnam aldehyde, catechin, |
| | cassia | | | epicatechin, procyanidin B2, |
| | | | | quercitrin, protocatechuic acid |
| | | | | and cinnamic acid |
| 2. | Cuminum cyminum | Cumin | Seed | Cumin aldehyde, alkaloid, |
| | | | | anthraquinone, coumarin |
| 3. | Piper nigrum | Black pepper | Fruit | Piperine, amides, piperidine, |
| | | | | pyrrolidines, and trace amounts |
| | | | | of safrole |
| 4. | Piper longum | Long pepper | Fruit | Piperine along with methyl |
| | | | | piperine, iperonaline, asarinine, |
| | | | | pellitorine, piperlongumine, |
| | | | | piperlonguminine, Brachystamide- |
| | | | | A, pipercide and piperidine |
| 5. | Syzygium | Clove | Fruit | Eugenyl acetate, eugenol, and |
| | aromaticum | | | β-caryophyllene |
| 6. | Allium sativum | Garlic | Root bulb | alliin, allicin, ajoenes, |
| | | | | vinyldithiins, and flavonoids |
| | | | | such as quercetin |
| 7. | Zingiber officinale | Ginger | Root | gingerols, shogaols, and paradols |
| | | | rhizome | |
| 8. | Pongamia pinnata | Karanja | Kernel | pongamol, karanjin, glabrin, |
| | | | | pongal, and kanjone |
| 9. | Anethum | dill | Seed | alkaloids, flavonoids, tannins, |
| | graveolens | | | saponins and cardiac glycosides |
| 10. | Citrus sinensis | Orange | whole fruit | limonene, γ-terpinene, β-pinene, |
| | | | | linalool, sabinene, myrcene, |
| | | | | α-terpineol, and α-pinene, alkaloid, |
| | | | | tannin, saponin, glycoside, |
| | | | | flavonoid, terpenoid, and phenols. |
| 11. | Melaleuca | Tea tree | Aerial | terpinen-4-ol, γ-terpinene, |
| | alternifolia | | Parts | α-terpinene, α-pinene, 1,8 cineole |
| | | | | and linalool |
| 12. | Cinnamomum | Camphor | Bark | linalool, 1,8-cineole, α-terpineol, |
| | camphora | | | isoborneol , β-phellandrene , and |
| | | | | camphor |
| 13. | Acorus calamus | sweet flag | Root | [symbol] |
| | | | rhizome | isoeugenol and their methyl ethers, |
| | | | | camphene, P-cymene, |
| | | | | [symbol] |
| | | | | terpinen-4-ol, aterpineol and a |
| | | | | calacorene, acorone, |
| | | | | acrenone, acoragermacrone, |
| | | | | 2-deca -4,7 dienol, |
| | | | | shyobunones, linalool and |
| | | | | preisocalamendiol |
| 14. | Annona squamosa | sugar-apples | Seed | Annonacin, Squamocin, Annonin |
| 15. | Azadirachta indica | Neem | Kernel | azadirachtin, nimbolinin, nimbin, |
| | | | | nimbidin, nimbidol, salannin, and |
| | | | | quercetin |
| 16. | Ricinus communis | castor | Seeds | kaempferol-3-O and kaempferol- |
| | | | | 3-O- β -D-glucopyranoside, |
| | | | | ingenol] triterpenoids (lupeol, β - |
| | | | | and α -amyrin), quercetin and |
| | | | | gallic acid, athujone, camphor and |
| | | | | beta thujone, ricin, epicatechin, |
| | | | | gentisic acid, catechin, linoleic |
| | | | | acid and ricinoleic acid, |
| | | | | kaempferol-3-O- β -D- |
| | | | | glucopyranoside and quercetin-3- |
| | | | | O- β -monoterpenoids |
| 17. | Sesamum indica | Sesamum | Seeds | sesamin, sesaminol, gamma |
| | | | | tocopherol, cephalin and lecithin |
| 18. | Brassica napus | Indian Mustard | seeds | polyphenols, phenolic acids, |
| | | | | flavonoids, carotenoids |
| | | | | (zeaxanthin, lutein, β-carotene), |
| | | | | Brassinolide, alkaloids, tannins, |
| | | | | saponins, anthocyanins, |
| | | | | phytosterols chlorophyll, |
| | | | | glucosinolates, phytosteroids, |
| | | | | terpenoids, glycosides. |
| 19. | Lantana camara | Lantana | Laves | tannin, saponin, flavonoids, |
| | | | | terpenoids, alkaloids, |
| | | | | carbohydrate, anthroquinone and |
| | | | | polyphenols |
| 20. | Parthenium | Santa-Maria | Aerial | sesquiterpene lactones, parthenin, |
| | hysterophorus | | parts | quercelagetin, p-hydroxybenzene, |
| | | | | vanillic acids, caffeic acids, |
| | | | | p-coumaric acids, p-anisic acids, |
| | | | | chlorogenic acids, ferulic acids |
| 21. | Rosmarinus | Rosemary | Aerial | pigenin, diosmin, luteolin, |
| | officinalis | | parts | genkwanina and phenolic acids |
| | | | | rosmarinic acid, chlorogenic acid |
| | | | | and caffeic acid |
| 22. | Ocimum sanctum | Basil | Aerial | oleanolic acid, rosmarinic acid, |
| | | | parts | ursolic acid, eugenol, methyl |
| | | | | eugenol, linalool, carvacrol, β |
| | | | | elemene, β caryophyllene, |
| | | | | germacrene |
| 23. | Acacia concinna | Shikakai | Fruit | lupeol, spinasterol, acacic acid, |
| | | | | lactone and natural sugars glucose, |
| | | | | arabinose and rhamnose |
| 24. | Mentha piperita | peppermint | Aerial | menthol, menthofuran, menthyl |
| | | | parts | acetate , menthone , and 1,8- |
| | | | | cineole |

[symbol]

indicates data missing or illegible when filed

### Example 3: Composition of Botanical Based Bio-Acaricide 1

TABLE 3

| Sr | | | |
|---|---|---|---|
| No. | Ingredient | Actual Percent | Percent Range |
| 1. | Brassica napus | 8.0% | 0.00 1 to 35% |
| 2. | Piper nigrum | 8.0% | 0.001 to 35% |
| 3. | Allium sativum | 9.0% | 0.001 to 40% |
| 4. | Adjuvant | 10.0% | 0.001 to 25% |
| 5. | Acorus calamus | 10.0% | 0.001 to 35% |
| 6. | Gaur gum | 4.2% | 0.001 to 18% |
| 7. | ethoxylated castor oil | 5.8% | 0.001 to 20% |
| 8. | Carrier oil (canola oil) | 45.0% | 0.001 to 90% |

### Preparation of Botanical Based Bio-Acaricide 1

The process for preparing Bio-acaricide 1 comprises the steps of:
1. Brassica napus dried seeds were extracted by using Solvent extraction technique by using Isopropyl alcohol as solvent. More precisely the entire extraction was carried between 10 degree celsius to 60 degree celsius under vacuum in accordance to preserve heat sensitive molecules. Further enrichment and purification of above obtain extract was performed by using Column chromatography technique by using silica gel as matrix, followed by precipitation and crystallisation etc. to obtain purified phyto ingredients such as but not limited to Brassinosteroid polyphenols, phenolic acids, flavonoids, carotenoids (zeaxanthin, lutein, β-carotene), alkaloids, tannins, saponins, anthocyanins, phytosterols chlorophyll, glucosinolates, phytosteroids, terpenoids, glycosides etc.
2. Piper nigrum dried fruits were extracted by using Solvent extraction technique by using ethyl acetate and methanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvents as medium, followed by precipitation and crystallisation etc. to obtain purified phyto ingredients such as but not limited to Piperine, amides, piperidine, pyrrolidines etc.
3. Allium sativum bulbs were extracted by using Solvent extraction technique by using ethyl acetate and methanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvents as medium, followed by precipitation and crystallisation etc. to obtain purified phyto ingredients such as but not limited to alliin, allicin, ajoenes, vinyldithiins, and flavonoids such as quercetin etc.
4. Above ingredients (from step no 1 to 3) were mixed with given proportion along with adjuvant any one or more than one silicone polyether, amine surfactant or amine surfactant ingredient, lecithin or lecithin, polyethylene oxide, polyethylene in given proportion.
5. Above ingredients (from step no 1 to 4) were mixed with given proportion along with Indian soapberry as organic emulsifier and poly sorbate 20 as Anionic and and ethoxylated castor oil as non-anionic emulsifier to at specific concentration.
6. Blend prepared in step no 5 was mixed with canola oil in given proportion.
7. Blend prepared in step no.6 was stirred at 300 to 1000 rpm at 25 to 55 degrees Celsius in close mixing vessel made up of stainless steel 316 grade with outer jacket for maintaining temperature. mixing vessel is connected with stirrer (blade stirrer, propeller stirrer, turbine stirrer, anchor stirrer, universal stirrer) for continues stirring towards the bottom of vessel homogenizer with the speed of 3700˜27000 rpm is attached to reduce the particle size under very high pressures, sheer, turbulence, acceleration and impact, to make them more stable and effective.
8. Blend prepare in step no 7 was passed through in line shear pump with 1800 RPM to 5800 RPM to reduce particle size in nano, so as to achieve nano emulsion with particle size ranging from 10 to 900 nano meter.
9. Further to obtain nano particles base formulation the blend formed in step no 8 was further passed through High-pressure homogenization (homogenization at speed of 4000 rpm to 10000 rpm and pressure max up to 4,200 bar (60,000 psi)) will reduce the particle size below 100 nano meters.
10. After passing through high pressure homogenizer the material was passed through sparkler filter having seven layers of membrane filters with pore size less than 1-2 micron to achieve proper filtration.

Product recovered from step 10 was further quantified for the active phyto constituent by using various instruments but not limited to High pressure liquid chromatograph, gas chromatography and spectroscopy compounds.

It was also tested for bio-efficacy against pests on different crops in vitro and in vivo, and compared to other chemically synthesised pesticides.

### Example 4: Composition of Botanical Based Bio-Acaricide 2

TABLE 4

| Sr | | | |
|---|---|---|---|
| No. | Ingredient | Actual Percent | Percent Range |
| 1. | Lantana camara | 1.00% | 0.00 1 to 35% |
| 2. | Piper nigrum | 5.5% | 0.001 to 35% |
| 3. | Cinnamomum camphora | 3.00% | 0.001 to 40% |
| 4. | Piper longum | 2.8% | 0.001 to 25% |
| 5. | Ocimum santum | 5.8% | 0.001 to 35% |
| 6. | Citrus sinensis | 5.00% | 0.001 to 25% |
| 7. | Gaur gum | 4.2% | 0.001 to 18% |
| 8. | ethoxylated castor oil | 5.8% | 0.001 to 20% |
| 9. | Carrier oil (Sesame oil) | 64.75% | 0.001 to 90% |

### Preparation of Botanical Based Bio-Acaricide 2:

The process for preparing the Botanical based Bio-acaricide 2 comprises the steps of:
1. Lantana camara aerial parts were extracted by using Solvent extraction technique by using methanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid chromatography technique by using two immiscible solvent as medium, followed by precipitation and crystallisation etc. to obtain purified phyto ingredients such as but not limited to tannin, saponin, flavonoids, terpenoids, alkaloids, carbohydrate, anthroquinone and polyphenols etc.
2. Piper nigrum dried fruit were extracted by using Solvent extraction technique by using ethyl acetate and methanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to Piperine, amides, piperidine, pyrrolidines etc.
3. Cinnamomum camphora dried leaf and bark were extracted by using Solvent extraction techniques by using ethyl acetate and methanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to linalool, 1,8-cineole, α-terpineol, isoborneol, β-phellandrene, and camphor etc.
4. Piper longum dried aerial parts were extracted by using Solvent extraction technique by using ethyl acetate as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to Piperine along with methyl piperine, iperonaline, asarinine, pellitorine, piperlongumine, piperlonguminine, Brachystamide-A, pipercide and piperidine etc.
5. Ocimum santum dried aerial parts were extracted by using Solvent extraction technique by using ethyl acetate and methanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to oleanolic acid, rosmarinic acid, ursolic acid, eugenol, methyl eugenol, linalool, carvacrol, β elemene, β caryophyllene, germacrene etc.
6. Citrus sinensis leaf & dried fruit parts were extracted by using Steam distillation extraction technique by using saturated steam as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium/matrix, followed by precipitation and crystallisation etc. to obtain purified phyto ingredients such as but not limited to Pinene (β), Limonene, Terpinene (γ), Terpinen-4-ol, Neral Geranial etc.
7. Above ingredients (from step no 1 to 6) were mixed with given proportion along with Rice bran wax as organic emulsifier and poly sorbate 20 as Anionic emulsifier and ethoxylated castor oil as non-anionic emulsifier at specific concentration.
8. Blend prepared in step no 7 was mixed with Sesame oil in given proportion.
9. Blend prepared in step no.8 was stirred at 300 to 1000 rpm at 25 to 55 degrees Celsius in close mixing vessel made up of stainless steel 316 grade with outer jacket for maintaining temperature. Mixing vessel is connected with stirrer (blade stirrer, propeller stirrer, turbine stirrer, anchor stirrer, universal stirrer) for continues stirring. towards the bottom of vessel homogenizer with the speed of 3700˜27000 rpm is attached to reduce the particle size under very high pressures, sheer, turbulence, acceleration and impact, to make them more stable and effective.
10. Blend prepare in step no 9 was passed through in line shear pump with 1800 RPM to 5800 RPM to reduce particle size in nano, so as to achieve nano emulsion with particle size ranging from 10 to 900 nano meter.
11. Further to obtain nano particles base formulation the blend formed in step no 11 was further passed through High-pressure homogenization (homogenization at speed of 4000 rpm to 10000 rpm and pressure max up to 4,200 bar (60,000 psi)) will reduce the particle size below 100 nano meters.
12. After passing through high pressure homogenizer the material was passed through sparkler filter having seven layers of membrane filters with pore size less than 1-2 micron to achieve proper filtration.

Product recovered from step 12 was further quantified for the active phyto constituent by using various instruments but not limited to High pressure liquid chromatograph and gas chromatography.

It was also tested for bio-efficacy against pests on different crops in vitro and in vivo, and compared to other chemically synthesised pesticides.

### Example 5: Composition of Botanical Based Bio-Acaricide 3

TABLE 5

| Sr | | | |
|---|---|---|---|
| No. | Ingredient | Actual Percent | Percent Range |
| 1. | Cinnamomum cassia | 8.0% | 0.00 1 to 35% |
| 2. | Piper nigrum | 1.50% | 0.001 to 35% |
| 3. | Allium sativum | 6.0% | 0.001 to 40% |
| 4. | Ocimum sanctum | 3.0% | 0.001 to 25% |
| 5. | Syzygium aromaticum | 4.0% | 0.001 to 35% |
| 6. | Gaur gum | 4.2% | 0.001 to 18% |
| 7. | ethoxylated castor oil | 5.8% | 0.001 to 20% |
| 8. | Carrier oil (canola oil) | 65.0% | 0.001 to 90% |

### Process of Preparation of Botanical Based Bio-Acaricide 3:

The process for preparing Botanical based Bio-acaricide 3 comprises the steps:
1. Cinnamomum cassia dried leaf and bark were extracted by using Solvent extraction technique by using ethyl acetate as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using immiscible solvents as medium, followed by precipitation and crystallisation etc. to obtain purified phyto ingredients such as but not limited to Cinnamic aldehyde, catechin, epicatechin, procyanidin B2, quercitrin, 3,4-dihydroxybenzaldehyde, protocatechuic acid and cinnamic acid etc.
2. Piper nigrum dried fruits were extracted by using Solvent extraction technique by using ethyl acetate as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to isoeugenol and their Piperine, amides, piperidine, pyrrolidines etc.
3. Allium sativum dried bulbs were extracted by using extraction technique by using methanol and ethanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to alliin, allicin, ajoenes, vinyldithiins, and flavonoids such as quercetin etc.
4. Ocimum sanctum dried aerial parts were extracted by using Super critical carbon dioxide extraction technique by using super critical carbon dioxide as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to oleanolic acid, rosmarinic acid, ursolic acid, eugenol, methyl eugenol, linalool, carvacrol, β elemene, β caryophyllene, germacrene etc.
5. Syzygium aromaticum dried fruit were extracted by using Solvent extraction technique by using ethyl acetate as solvent. More precisely the entire extraction was carried between 10 degree Celsius to 60 degree Celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to Eugenyl acetate, eugenol, and β-caryophyllene etc.
6. Above ingredients (from step no 1 to 5) were mixed with given proportion along with Gaur gum as organic emulsifier and polysorbate 20 as Anionic emulsifier and ethoxylated castor oil as non-anionic emulsifier to at specific concentration.
7. Blend prepared in step no 6 was mixed with canola oil in given proportion.
8. Blend prepared in step no.7 was stirred at 300 to 1000 rpm at 25 to 55 degrees Celsius in close mixing vessel made up of stainless steel 316 grade with outer jacket for maintaining temperature. mixing vessel is connected with stirrer (blade stirrer, propeller stirrer, turbine stirrer, anchor stirrer, universal stirrer) for continues stirring. towards the bottom of vessel homogenizer with the speed of 3700˜27000 rpm is attached to reduce the particle size under very high pressures, sheer, turbulence, acceleration and impact, to make them more stable and effective.
9. Blend prepare in step no 8 was passed through in line shear pump with 1800 RPM to 5800 RPM to reduce particle size in nano, so as to achieve nano emulsion with particle size ranging from 10 to 900 nano meter.
10. Further to obtain nano particles base formulation the blend formed in step no 10 was further passed through High-pressure homogenization (homogenization at speed of 4000 rpm to 10000 rpm and pressure max up to 4,200 bar (60,000 psi)) will reduce the particle size below 100 nano meters.
11. After passing through high pressure homogenizer the material was passed through sparkler filter having seven layers of membrane filters with pore size less than 1-2 micron to achieve proper filtration.

Product recovered from step 11 was further quantified for the active phyto constituent by using various instruments but not limited to liquid chromatography-mass spectrometry, gas chromatography-mass spectrometry, High pressure liquid chromatograph, gas chromatography, spectroscopy compounds etc.

It was also tested for bio-efficacy against pests on different crops in vitro and in vivo, and compared to other chemically synthesised pesticides.

### Example 6: Composition of Botanical Based Bio-Acaricide 4

TABLE 6

| Sr | | | |
|---|---|---|---|
| No. | Ingredient | Actual Percent | Percent Range |
| 1. | Rosmarinus officinalis | 10.0% | 0.00 1 to 35% |
| 2. | Lantana camara | 5.0% | 0.001 to 35% |
| 3. | Annona squamosa | 2.5% | 0.001 to 40% |
| 4. | Azadirachta indica | 5.0% | 0.001 to 25% |
| 5. | Pongamia pinnata | 2.5% | 0.001 to 35% |
| 8. | Gaur gum | 4.2% | 0.001 to 18% |
| 9. | ethoxylated castor oil | 5.8% | 0.001 to 20% |
| 10. | Carrier oil (canola oil) | 65.0% | 0.001 to 90% |

### Preparation of Botanical Based Bio-Acaricide 4:

The process for preparing Bio-acaricide 4 comprises the steps of:
1. Rosmarinus officinalis dried leaf and bark were extracted by using Solvent extraction technique by using methanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to pigenin, diosmin, luteolin, genkwanina and phenolic acids rosmarinic acid, chlorogenic acid and caffeic acid etc.
2. Lantana camara dried fruits were extracted by using Solvent extraction technique by using ethyl acetate and acetone as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to isoeugenol and their tannin, saponin, flavonoids, terpenoids, alkaloids, carbohydrate, anthroquinone and polyphenols etc.
3. Annona squamosa dried bulbs were extracted by using Solvent extraction techniques by using methanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using immiscible solvent as medium, followed by precipitation and crystallisation etc. to obtain purified phyto ingredients such as but not limited to Annonacin, Squamocin, Annonin etc.
4. Azadirachta indica dried aerial parts were extracted by using Solvent extraction technique by using ethyl acetate as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to azadirachtin, nimbolinin, nimbin, nimbidin, nimbidol, salannin, and quercetin etc.
5. Pongamia pinnata dried seeds were extracted by using Solvent extraction technique by using hexane as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified Phyto ingredients such as but not limited to pongamol, karanjin, glabrin, pongal, and kanjone etc.
6. Above ingredients (from step no 1 to 5) were mixed with given proportion along with Indian soap berry aqueous extract as organic emulsifier and polysorbate 20 as Anionic emulsifier and ethoxylated castor oil as non-anionic emulsifier at specific concentration.
7. Blend prepared in step no 6 was mixed with Canola oil in given proportion.
8. Blend prepared in step no.7 was stirred at 300 to 1000 rpm at 25 to 55 degrees Celsius in close mixing vessel made up of stainless steel 316 grade with outer jacket for maintaining temperature. mixing vessel is connected with stirrer (blade stirrer, propeller stirrer, turbine stirrer, anchor stirrer, universal stirrer) for continues stirring. towards the bottom of vessel homogenizer with the speed of 3700˜27000 rpm is attached to reduce the particle size under very high pressures, sheer, turbulence, acceleration and impact, to make them more stable and effective.
9. Blend prepare in step no 8 was passed through in line shear pump with 1800 RPM to 5800 RPM to reduce particle size in nano, so as to achieve nano emulsion with particle size ranging from 10 to 900 nano meter.
10. Further to obtain nano particles base formulation the blend formed in step no 9 was further passed through High-pressure homogenization (homogenization at speed of 4000 rpm to 10000 rpm and pressure max up to 4,200 bar (60,000 psi)) will reduce the particle size below 100 nano meters.
11. After passing through high pressure homogenizer the material was passed through sparkler filter having seven layers of membrane filters with pore size less than 1-2 micron to achieve proper filtration.

Product recovered from step 11 was further quantified for the active phyto constituent by using various instruments but not limited to liquid chromatography-mass spectrometry, gas chromatography-mass spectrometry, High pressure liquid chromatograph, gas chromatography, spectroscopy compounds etc.

It was also tested for bio-efficacy against pests on different crops in vitro and in vivo, and it is compared to other chemically synthesised pesticides.

### Example 7: Composition of Botanical Based Bio-Acaricide 5

TABLE 7

| Sr | | | |
|---|---|---|---|
| No. | Ingredient | Actual Percent | Percent Range |
| 1. | Syzygium aromaticum | 5.50% | 0.00 1 to 35% |
| 2. | Piper nigrum | 3.75% | 0.001 to 35% |
| 3. | Allium sativum | 2.00% | 0.001 to 25% |
| 4. | Zingiber officinale | 5.25% | 0.001 to 35% |
| 5. | Cinnamomum cassia | 6.00% | 0.001 to 35% |
| 6. | Gaur gum | 4.2% | 0.001 to 18% |
| 7. | ethoxylated castor oil | 5.8% | 0.001 to 20% |
| 8. | Carrier oil (canola oil) | 62.0% | 0.001 to 90% |

### Preparation of Botanical Based Bio-Acaricide 5:

The process for preparing Bio-acaricide 5 comprises the steps of:
1. Syzygium aromaticum aerial parts were extracted by using Solvent extraction techniqueby using ethyl acetate as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to Eugenyl acetate, eugenol, and β-caryophyllene etc.
2. Piper nigrum bark and leaf parts were extracted by using Solvent extraction technique by using ethyl acetate solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to Piperine, amides, piperidine, pyrrolidines, and trace amounts of safrole etc.
3. Allium sativum dried aerial parts were extracted by using Solvent extraction techniques by using methanol and ethanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to alliin, allicin, ajoenes, vinyldithiins, and flavonoids such as quercetin etc.
4. Zingiber officinale dried leaf were extracted by using Solvent extraction technique by using ethyl acetate as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to gingerols, shogaols, and paradols etc.
5. Cinnamomum cassia dried roots were extracted by using Solvent extraction technique by using ethyl acetate and hexane as solvent. More precisely the entire extraction was carried between 10 degree celsius to 60 degree Celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to cinnamic aldehyde, catechin, epicatechin, procyanidin B2, quercitrin, 3,4-dihydroxybenzaldehyde, protocatechuic acid and cinnamic acid etc.
6. Above ingredients (from step no 1 to 5) were mixed with given proportion along with Gaur gum as organic emulsifier and polysorbate 20 as Anionic emulsifier and ethoxylated castor oil as non-anionic emulsifier to at specific concentration.
7. Blend prepared in step no 6 was mixed with canola oil in given proportion.
8. Blend prepared in step no. 7 was stirred at 300 to 1000 rpm at 25 to 55 degrees Celsius in close mixing vessel made up of stainless steel 316 grade with outer jacket for maintaining temperature. mixing vessel is connected with stirrer (blade stirrer, propeller stirrer, turbine stirrer, anchor stirrer, universal stirrer) for continues stirring towards the bottom of vessel homogenizer with the speed of 3700˜27000 rpm is attached to reduce the particle size under very high pressures, sheer, turbulence, acceleration and impact, to make them more stable and effective.
9. Blend prepare in step no 8 was passed through in line shear pump with 1800 RPM to 5800 RPM to reduce particle size in nano, so as to achieve nano emulsion with particle size ranging from 10 to 900 nano meter.
10. Further to obtain nano particles base formulation the blend formed in step no 10 was further passed through High-pressure homogenization (homogenization at speed of 4000 rpm to 10000 rpm and pressure max up to 4,200 bar (60,000 psi)) will reduce the particle size below 100 nano meters.
11. After passing through high pressure homogenizer the material was passed through sparkler filter having seven layers of membrane filters with pore size less than 1-2 micron to achieve proper filtration.

Product recovered from step 11 was further quantified for the active phyto constituent by using various instruments but not limited to liquid chromatography-mass spectrometry, gas chromatography-mass spectrometry, High pressure liquid chromatograph, gas chromatography, spectroscopy compounds etc.

It was also tested for bio-efficacy against pests on different crops in vitro and in vivo, and compared to other chemically synthesised pesticides.

### Example 8: Composition of Botanical Based Bio-Acaricide 6

TABLE 8

| Sr No. | Ingredient | Actual Percent | Percent Range |
|---|---|---|---|
| 1. | Cinnamomum cassia | 10.00% | 0.00 1 to 35% |
| 2. | Citrus sinensis | 6.00% | 0.001 to 35% |
| 3. | Allium sativum | 5.00% | 0.001 to 40% |
| 4. | Melaleuca alternifolia | 3.5% | 0.001 to 25% |
| 5. | Cuminum cyminum | 3.00% | 0.001 to 35% |
| 8. | Gaur gum | 4.2% | 0.001 to 18% |
| 9. | ethoxylated castor oil | 5.8% | 0.001 to 20% |
| 10. | Carrier oil (canola oil) | 65.0% | 0.001 to 90% |

### Preparation of Botanical Based Bio-Acaricide 6:

The process for preparing Bio-acaricide 6 comprises the steps of:
1. Cinnamomum cassia aerial parts were extracted by using Solvent extraction technique by using ethyl acetate and hexane as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to Cinnam aldehyde, catechin, epicatechin, procyanidin B2, quercitrin, 3,4-dihydroxybenzaldehyde, protocatechuic acid and cinnamic acid etc.
2. Citrus sinensis bark and leaf parts were extracted by using Steam distillation extraction technique by using steam as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to limonene, γ-terpinene, β-pinene, linalool, sabinene, myrcene, α-terpineol, and α-pinene, alkaloid, tannin, saponin, glycoside, flavonoid, terpenoid, and phenols etc.
3. Allium sativum dried fruits were extracted by using Solvent extraction technique by using methanol and ethanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to alliin, allicin, ajoenes, vinyldithiins, and flavonoids such as quercetin etc.
4. Melaleuca alternifolia dried aerial parts were extracted by using Solvent extraction technique by using ethyl acetate and methanol as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to terpinen-4-ol, γ-terpinene, α-terpinene, α-pinene, 1,8 cineole and linalool etc.
5. Cuminum cyminum dried leaf were extracted by using Solvent extraction technique by using ethyl acetate as solvent. More precisely the entire extraction was carried between 10 degree celsius to 60 degree celsius under vacuum in accordance to preserve heat sensitive molecules. Further enrichment and purification of above obtain extract was performed by using Liquid-liquid extraction technique by using two immiscible solvent as medium, followed by precipitation and crystallisation etc. to obtain purified phyto ingredients such as but not limited to Cumin aldehyde, alkaloid, anthraquinone, coumarin, flavonoid, glycoside, protein, resin, saponin, tannin and steroid etc.
6. Above ingredients (from step no 1 to 5) were mixed with given proportion along with Gaur gum as organic emulsifier and polysorbate 20 as Anionic and ethoxylated castor oil as non-anionic emulsifier at specific concentration.
7. Blend prepared in step no 6 was mixed with Canola oil in given proportion.
8. Blend prepared in step no.7 was stirred at 300 to 1000 rpm at 25 to 55 degrees Celsius in close mixing vessel made up of stainless steel 316 grade with outer jacket for maintaining temperature. mixing vessel is connected with stirrer (blade stirrer, propeller stirrer, turbine stirrer, anchor stirrer, universal stirrer) for continues stirring. towards the bottom of vessel homogenizer with the speed of 3700˜27000 rpm is attached to reduce the particle size under very high pressures, sheer, turbulence, acceleration and impact, to make them more stable and effective.
9. Blend prepare in step no 8 was passed through in line shear pump with 1800 RPM to 5800 RPM to reduce particle size in nano, so as to achieve nano emulsion with particle size ranging from 10 to 900 nano meter.
10. Further to obtain nano particles base formulation the blend formed in step no 9 was further passed through High-pressure homogenization (homogenization at speed of 4000 rpm to 10000 rpm and pressure max up to 4,200 bar (60,000 psi)) will reduce the particle size below 100 nano meters.
11. After passing through high pressure homogenizer the material was passed through sparkler filter having seven layers of membrane filters with pore size less than 1-2 micron to achieve proper filtration.

Product recovered from step 11 was further quantified for the active phyto constituent by using various instruments but not limited to liquid chromatography-mass spectrometry, gas chromatography-mass spectrometry, High pressure liquid chromatograph, gas chromatography, spectroscopy compounds etc.

It was also tested for bio-efficacy against pests on different crops in vitro and in vivo, and compared to other chemically synthesised pesticides.

### Example 9: Effect of Bio-Stimulant on Yield of Orange

Name of the Product: Bio Acaricide Pest: Mite
Variety: Nagpur Orange Crop: Orange

### Material and Method

A field experiment was conducted at Kay Bee R & D Farm, Ahmednagar (MS) during Summer season 2021-2022. The experimental site under sub-tropical climatic condition. The experiment consisted of ten treatments as presented in Table 9. The orange variety Nagpur Orange was used and experiment was arranged in Randomized Block Design with three replications. All the recommended practices were applied as per stage and condition of crop. The spraying of the formulation was conducted at 35 and 55 Days After Flowering (DAF). The yield and yield contributing data were recorded as per the crop stage of occurrence. Collected data on different parameters were statistically analyzed by using “analysis of variance method (ANOVA)” (Panse and Sukhatme, 1967).

### Results

The data on effect of bio-stimulant on growth and yield of orange were recorded statistically significant result and are furnished in Table 9.

TABLE 9
Response of Bio-stimulants on Orange.

| | | | Fruit | | | |
|---|---|---|---|---|---|---|
| | | | Retention | Fruit | | Fruit |
| Tr. | | Dose | % at | Weight | Juice | yield |
| No. | Treatment. Code | (ml/lit.) | Maturity | (g) | (%) | (t/ha) |
| 1 | Bio Acaricide | 0.50 | 27.40 | 139.45 | 59.56 | 11.13 |
| 2 | Bio Acaricide | 1.00 | 30.87 | 145.38 | 60.43 | 11.45 |
| 3 | Bio Acaricide | 2.00 | 37.63 | 167.92 | 63.23 | 12.23 |
| 4 | Nutrozen (Plant derived nutrition | 2.00 | 41.37 | 180.34 | 72.33 | 13.78 |
| | along with the necessary | | | | | |
| | hormones, vitamins and sea weed | | | | | |
| | extract) | | | | | |
| 5 | Isabion (Organic fraction derived | 2.00 | 43.57 | 183.78 | 69.82 | 12.03 |
| | from Amino Acid and peptides | | | | | |
| | mixture 62.5%) | | | | | |
| 6 | Biozyme Crop+ (Seaweed | 2.00 | 39.53 | 170.23 | 67.82 | 12.45 |
| | Extract, Proteins, Carbohydrates, | | | | | |
| | Inorganic Salts and Other Inherent | | | | | |
| | Nutrients) 22% | | | | | |
| 7 | Double (Homobrassinolide | 0.50 | 36.67 | 151.67 | 63.65 | 11.54 |
| | 0.04%) | | | | | |
| 8 | Macarena (Fermented extract | 1.25 | 40.70 | 174.92 | 72.70 | 13.37 |
| | Nutrient 15%) | | | | | |
| 9 | Hoshi (Gibberellic Acid 0.001%) | 2.00 | 33.83 | 160.12 | 63.33 | 11.98 |
| 10 | Water Control | — | 23.00 | 127.43 | 57.34 | 10.50 |

| | | | | |
|---|---|---|---|---|
| SE ± | 1.24 | 2.12 | 0.32 | 1.32 |
| C.D. 0.05% | 3.7 | 6.35 | 0.96 | 3.97 |

### CONCLUSION

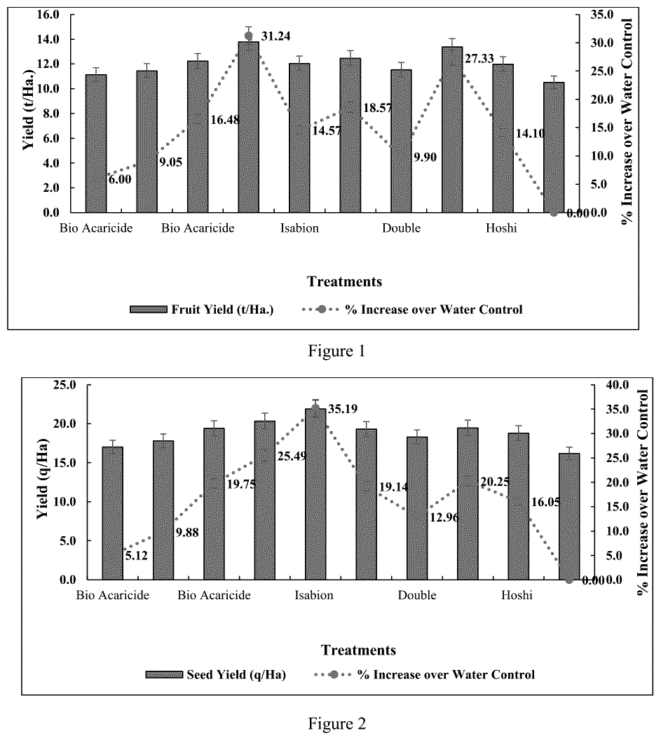

All the doses of Bio Acaricide reported significant improvement over water control in all the recorded parameters. The treatment Neutrozen reported maximum yield with morphology development than rest of the treatments. The Bio Acaricide @ 2 ml/lit. also noted maximum yield improvement over Double 0.5 ml/lit. and Hoshi 2 ml/lit (FIG. 1).

### Example 10: Effect of Bio-Stimulant on Growth and Yield of Soybean

Name of the Product: Bio Acaricide Pest: Mite
Variety: Phule Sangam Crop: Soybean

### Material and Method

A field experiment was conducted at Kay Bee R & D Farm, Phaltan (MS) during kharif season 2021-2022. The experimental site under subtropical climatic condition. The experiment consisted of ten treatments as presented in Table 10. The Soybean variety Phule Sangam was used and experiment was arranged in Randomized Block Design with three replications. The net size of each plot was 4 m×3.65 m². All the recommended practices were applied as per stage and condition of crop. The spraying of the formulation was conducted at 20 and 50 Days After Sowing (DAS). The morphological data like plant height and number of branches were recorded at physiological maturity. The data on chlorophyll concentration index was recorded at 70 DAS with Chlorophyll Concentration Meter MC-100. The yield and yield contributing data were recorded as per the crop stage of occurrence. Collected data on different parameters were statistically analyzed by using “analysis of variance method (ANOVA)” (Panse and Sukhatme, 1967).

### Results

The data on effect of bio-stimulant on growth and yield of Soybean were recorded statistically significant result and are furnished in Table 10.

TABLE 10
Response of Bio-stimulants on Soybean.

| | | | Plant | No. of | Chlorophyll | | Seed |
|---|---|---|---|---|---|---|---|
| Tr. | | Dose | Height | Branches/ | Concentration | Days to | yield |
| No. | Treatment. Code | (ml/lit.) | (cm) | plant | Index (CCI) | Maturity | (q/ha) |
| 1 | Bio Acaricide | 0.50 | 51.13 | 11.07 | 31.00 | 98.20 | 17.03 |
| 2 | Bio Acaricide | 1.00 | 52.40 | 10.53 | 32.20 | 97.40 | 17.80 |
| 3 | Bio Acaricide | 2.00 | 60.45 | 12.70 | 33.80 | 96.33 | 19.40 |
| 4 | Nutrozen (Plant | 2.00 | 58.73 | 11.30 | 34.20 | 95.90 | 20.33 |
| | derived nutrition | | | | | | |
| | along with the | | | | | | |
| | necessary | | | | | | |
| | hormones, vitamins | | | | | | |
| | and sea weed | | | | | | |
| | extract) | | | | | | |
| 5 | Isabion (Organic | 2.00 | 63.49 | 11.43 | 35.46 | 92.17 | 21.90 |
| | fraction derived | | | | | | |
| | from Amino Acid | | | | | | |
| | and peptides | | | | | | |
| | mixture 62.5%) | | | | | | |
| 6 | Biozyme Crop+ | 2.00 | 57.14 | 12.33 | 33.49 | 97.77 | 19.30 |
| | (Seaweed Extract, | | | | | | |
| | Proteins, | | | | | | |
| | Carbohydrates, | | | | | | |
| | Inorganic Salts and | | | | | | |
| | Other Inherent | | | | | | |
| | Nutrients) 22% | | | | | | |
| 7 | Double | 0.50 | 62.15 | 13.83 | 32.44 | 93.80 | 18.30 |
| | (Homobrassinolide | | | | | | |
| | 0.04%) | | | | | | |
| 8 | Macarena | 1.25 | 59.55 | 10.33 | 33.68 | 94.70 | 19.48 |
| | (Fermented extract | | | | | | |
| | Nutrient 15%) | | | | | | |
| 9 | Hoshi (Gibberellic | 2.00 | 55.13 | 11.03 | 33.00 | 95.40 | 18.80 |
| | Acid 0.001%) | | | | | | |
| 10 | Water Control | — | 49.45 | 10.03 | 29.90 | 98.43 | 16.20 |

| | | | | | |
|---|---|---|---|---|---|
| SE ± | 1.28 | 0.27 | 0.21 | 1.43 | 1.01 |
| C.D. 0.05% | 3.85 | 0.81 | 0.64 | 4.29 | 3.04 |

### CONCLUSION

All the doses of Bio Acaricide reported significant improvement over water control in all the recorded parameters. The treatment Isabion reported maximum yield with morphology development than rest of the treatments. The Bio Acaricide @ 2 ml/lit. also noted maximum yield improvement over Biozyme Crop+2 ml/lit., Double 0.5 ml/lit. and Hoshi 2 ml/lit (FIG. 2).

### Example 11: Effect of Bio-Stimulant on Growth and Vield of Tomato

Name of the Product: Bio Acaricide Pest: Mite
Variety: Ansal Crop: Tomato

### Material and Method

A field experiment was conducted at Kay Bee R & D Farm, Phaltan (MS) during Rabi season 2021-2022. The experimental site under subtropical climatic condition. The experiment consisted of ten treatments as presented in Table 11. The Tomato variety Ansal was used and experiment was arranged in Randomized Block Design with three replications. The net size of each plot was 5.00 m×7.20 m². All the recommended practices were applied as per stage and condition of crop. The spraying of the formulation was conducted at 25, 45 and 65 Days After Transplanting (DAT). The morphological data like plant height and number of branches were recorded at physiological maturity. The yield and yield contributing data were recorded as per the crop stage of occurrence. Collected data on different parameters were statistically analyzed by using “analysis of variance method (ANOVA)” (Panse and Sukhatme, 1967).

### Results

The data on effect of bio-stimulant on growth and yield of tomato were recorded statistically significant result and are furnished in Table 11.

TABLE 11
Response of Bio-stimulants on Tomato

| | | | | | | No. of | |
|---|---|---|---|---|---|---|---|
| | | | Plant | No. of | Days to | Flower | Fruit |
| Tr. | | Dose | Height | Branches/ | flower | Cluster/ | yield |
| No. | Treatment. Code | (ml/lit.) | (cm) | Plant | initiation | Plants | (t/ha) |
| 1 | Bio Acaricide | 0.50 | 91.20 | 12.97 | 39.10 | 14.87 | 45.75 |
| 2 | Bio Acaricide | 1.00 | 92.53 | 13.47 | 38.92 | 15.33 | 46.82 |
| 3 | Bio Acaricide | 2.00 | 96.40 | 14.13 | 37.47 | 19.57 | 48.31 |
| 4 | Nutrozen (Plant derived | 2.00 | 100.25 | 14.90 | 36.10 | 19.53 | 49.52 |
| | nutrition along with the | | | | | | |
| | necessary hormones, | | | | | | |
| | vitamins and sea weed | | | | | | |
| | extract) | | | | | | |
| 5 | Isabion (Organic fraction | 2.00 | 109.72 | 20.10 | 33.66 | 23.33 | 55.15 |
| | derived from Amino Acid | | | | | | |
| | and peptides mixture | | | | | | |
| | 62.5%) | | | | | | |
| 6 | Biozyme Crop+ (Seaweed | 2.00 | 106.22 | 18.36 | 34.17 | 21.47 | 54.36 |
| | Extract, Proteins, | | | | | | |
| | Carbohydrates, Inorganic | | | | | | |
| | Salts and Other Inherent | | | | | | |
| | Nutrients) 22% | | | | | | |
| 7 | Double (Homobrassinolide | 0.50 | 94.23 | 13.93 | 38.65 | 17.87 | 46.73 |
| | 0.04%) | | | | | | |
| 8 | Vipul Booster | 1.25 | 103.57 | 15.87 | 35.46 | 18.33 | 51.67 |
| | (Triacontanol 0.1%) | | | | | | |
| 9 | Fantac Plus (L-cysteine | 1.50 | 98.62 | 14.30 | 36.85 | 20.17 | 48.93 |
| | based plant growth | | | | | | |
| | regulator-combination of | | | | | | |
| | amino acids and vitamins) | | | | | | |
| 10 | Water Control | — | 90.67 | 12.70 | 39.66 | 13.66 | 42.29 |

| | | | | | |
|---|---|---|---|---|---|
| SE ± | 1.84 | 0.85 | 1.34 | 0.92 | 1.56 |
| C.D. 0.05% | 5.5 | 2.51 | 3.99 | 2.74 | 4.87 |

### CONCLUSION

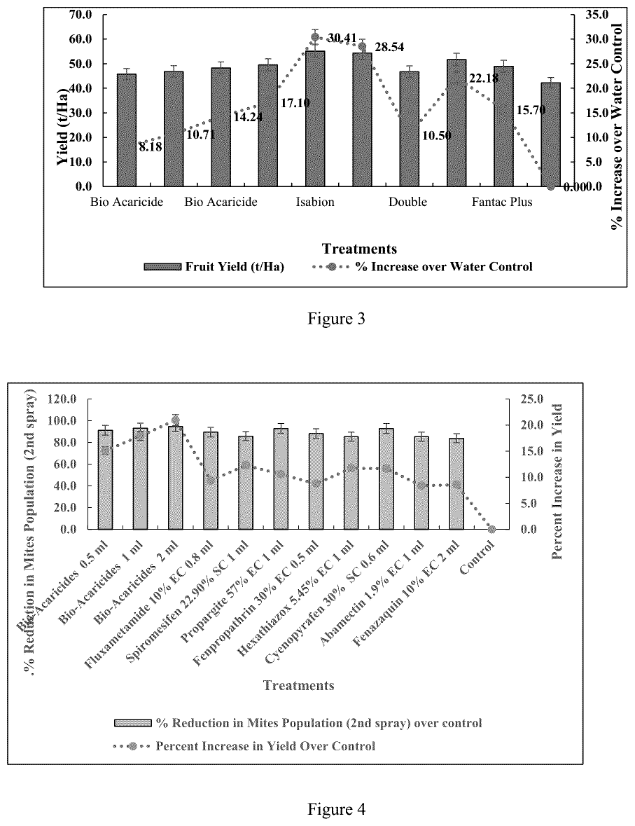

All the doses of Bio Acaricide reported significant improvement over water control in all the recorded parameters. The treatment Isabion reported maximum yield with morphology development than rest of the treatments. The Bio Acaricide @ 2 ml/lit. also noted maximum yield improvement over Double 0.5 ml/lit. and water control (FIG. 3).

### Example 12: Bio-Efficacy of Bio-Acaricide Against Red Mites in Citrus

Name of the Product: Bio-acaricide Variety: Nagpuri
Crop: Citrus Pest: Red Mite (Panonichus citri)

### Material and Method

A field experiment to study bio efficacy of Bio-acaricide in Citrus was conducted at Kay-Bee Bio-Organics Pvt. Ltd's. farm at Phaltan, District Satara (M. S.), India, during 2021-2022. The trial consisting of twelve treatments including untreated control was laid out in a Randomized Block Design with three replications. Citrus cultivated on following the standard spacing's 6 m×6 m to raise the good crop. Standard cultural practices were followed to grow a good crop. All the treatments were applied two times (Table 12). Observations on mite population were recorded by randomly selected five plants in each treatment. Three leaves/plant each from top, middle and bottom canopies were labelled to record mite population before spraying and after spraying using hand lens. The data were analyzed by using standard statistical methods.

$$Reduction over control ( \% ) = \frac{\begin{matrix}Population Count of Control Plot - \\ Population Count of Treated Plot\end{matrix}}{Population Count of Control Plot} * 100$$

TABLE 12

| Tr. No. | Treatments | Dose ml or gm/L | |
|---|---|---|---|
| T 1 | Bio- acaricide | 0.5 | ml |
| T 2 | Bio- acaricide | 1 | ml |
| T 3 | Bio- acaricide | 2 | ml |
| T 4 | Fluxametamide 10% EC | 0.8 | ml |
| T 5 | Spiromesifen 22.90% SC | 1 | ml |
| T 6 | Propargite 57% EC | 1 | ml |
| T 7 | Fenpropathrin 30% EC | 0.5 | ml |
| T 8 | Hexathiazox 5.45% EC | 1 | ml |
| T 9 | Cyenopyrafen 30% SC | 0.6 | ml |
| T 10 | Abamectin 1.9% EC | 1 | ml |
| T 11 | Fenazaquin 10% EC | 2 | ml |

| | | |
|---|---|---|
| T 12 | Control | — |

Results: The results are depicted in Table 13

TABLE 13

| | | | | 1^{st} spray | | 2^{nd} spray | | | |
|---|---|---|---|---|---|---|---|---|---|
| | | | | | % | | % | | |
| | | | | | Reduction | | Reduction | | |
| | | | | | in Mites | No. | in Mites | | % |
| | | | | | Population | of | Population | | Increase |
| | | | No. of | No. of | (1st | Mites | (2nd | | in |
| | | Dose | Mites | Mites | spray) | after | spray) | | Yield |
| Tr. | | ml or | before | after 1st | over | 2nd | over | Yield | over |
| No. | Treatments | gm/L | spray | spray | control | spray | control | (t/ha) | control |
| T 1 | Bio-acaricide | 0.5 ml | 27.02 | 6.32 | 83.93 | 4.12 | 91.04 | 29.02 | 15.06 |
| T 2 | Bio-acaricide | 1 ml | 23.06 | 5.36 | 86.37 | 3.20 | 93.04 | 30.02 | 17.89 |
| T 3 | Bio-acaricide | 2 ml | 24.48 | 4.44 | 88.71 | 2.46 | 94.65 | 31.18 | 20.94 |
| T 4 | Fluxametamide | 0.8 ml | 22.68 | 7.56 | 80.77 | 4.89 | 89.37 | 27.18 | 9.31 |
| | 10% EC | | | | | | | | |
| T 5 | Spiromesifen | 1 ml | 26.30 | 8.65 | 78.00 | 6.57 | 85.72 | 28.09 | 12.25 |
| | 22.90 % SC | | | | | | | | |
| T 6 | Propargite | 1 ml | 29.37 | 5.89 | 85.02 | 3.32 | 92.78 | 27.56 | 10.56 |
| | 57% EC | | | | | | | | |
| T 7 | Fenpropathrin | 0.5 ml | 20.89 | 6.89 | 82.48 | 5.46 | 88.13 | 27.01 | 8.74 |
| | 30% EC | | | | | | | | |
| T 8 | Hexathiazox | 1 ml | 18.26 | 7.48 | 80.98 | 6.78 | 85.26 | 27.92 | 11.71 |
| | 5.45% EC | | | | | | | | |
| T 9 | Cyenopyrafen | 0.6 ml | 26.75 | 5.78 | 85.30 | 3.33 | 92.76 | 27.89 | 11.62 |
| | 30% SC | | | | | | | | |
| T 10 | Abamectin | 1 ml | 23.86 | 6.45 | 83.60 | 6.78 | 85.26 | 26.89 | 8.33 |
| | 1.9% EC | | | | | | | | |
| T 11 | Fenazaquin | 2 ml | 22.90 | 8.96 | 77.21 | 7.48 | 83.74 | 26.96 | 8.57 |
| | 10% EC | | | | | | | | |
| T 12 | Control | — | 26.45 | 39.32 | — | 46.00 | — | 24.65 | — |

| | | | | | | | | |
|---|---|---|---|---|---|---|---|---|
| SE ± | — | 1.28 | 1.69 | — | 1.49 | — | 1.96 | — |
| C.D. (0.05) | — | N.S. | 5.12 | — | 4.42 | — | 5.82 | — |

### CONCLUSION

The results of the trial revealed that an application of Bio-acaricide @ 2 ml/l recorded the maximum reduction in Red Mite population of 88.71% over the control in 1^{st} spray and 94.65% reduction in Red Mite population after 2^{nd} spray over the control (FIG. 4).

The bio stimulant effect of Bio-acaricide with an application of 2 ml/l in Citrus exhibited the highest increase of 20.94% in yield over the control (FIG. 4).

### Example 13: Bio-Efficacy of Bio-Acaricide Against Red Mites in Rose

Name of the Product: Bio-acaricide Variety: Top Secret
Crop: Rose Pest: Red Mites (Tetranichus cinnabarinus)

### Material and Method

A field experiment to study bio efficacy of Bio-acaricide in Rose was conducted at Kay-Bee Bio-Organics Pvt. Ltd.'s farm at Phaltan, District Satara (M. S.), India, during 2021-2022. The trial consisting of twelve treatments including untreated control was laid out in a Randomized Block Design with three replications. Rose cultivated on following the standard spacing's 30 cm×15 cm to raise the good crop. Standard cultural practices were followed to grow a good crop. All the treatments were applied two times (Table 14). Observations on mite population were recorded by randomly selected five plants in each treatment. Three leaves/plant each from top, middle and bottom canopies were labelled to record mite population before spraying and after spraying using hand lens. The data were analyzed by using standard statistical methods.

$$Reduction over control ( \% ) = \frac{\begin{matrix}Population Count of Control Plot - \\ Population Count of Treated Plot\end{matrix}}{Population Count of Control Plot} * 100$$

TABLE 14

| Tr. No. | Treatments | Dose ml or gm/L | |
|---|---|---|---|
| T 1 | Bio-acaricide | 0.5 | ml |
| T 2 | Bio-acaricide | 1 | ml |
| T 3 | Bio-acaricide | 2 | ml |
| T 4 | Spiromesifen 22.90% SC | 1 | ml |
| T 5 | Abamectin 1.9% EC | 1 | ml |
| T 6 | Hexathiazox 5.45% EC | 1 | ml |
| T 7 | Cyenopyrafen 30% SC | 0.6 | ml |
| T 8 | Fluxametamide 10% EC | 0.8 | ml |
| T 9 | Fenpropathrin 30% EC | 0.5 | ml |
| T 10 | Propargite 57% EC | 1 | ml |
| T 11 | Fenazaquin 10% EC | 2 | ml |

| | | |
|---|---|---|
| T 12 | Control | — |

Results: The results are depicted in Table 15.

TABLE 15

| | | | | 1^{st} spray | | 2^{nd} spray | | | |
|---|---|---|---|---|---|---|---|---|---|
| | | | | | % | | % | | |
| | | | | | Reduction | | Reduction | | |
| | | | | | in Mites | No. | in Mites | | % |
| | | | | | Population | of | Population | | Increase |
| | | | No. of | No. of | (1st | Mites | (2nd | | in |
| | | Dose | Mites | Mites | spray) | after | spray) | Yield | Yield |
| Tr. | | ml or | before | after 1st | over | 2nd | over | (Stems/ | over |
| No. | Treatments | gm/L | spray | spray | control | spray | control | sqm) | control |
| T 1 | Bio-acaricide | 0.5 ml | 13.26 | 4.16 | 76.89 | 4.36 | 82.41 | 252 | 16.67 |
| T 2 | Bio-acaricide | 1 ml | 12.89 | 3.26 | 81.89 | 3.46 | 86.04 | 258 | 18.60 |
| T 3 | Bio-acaricide | 2 ml | 15.47 | 2.76 | 84.67 | 2.18 | 91.20 | 269 | 21.93 |
| T 4 | Spiromesifen | 1 ml | 17.84 | 5.17 | 71.28 | 6.32 | 74.50 | 239 | 12.13 |
| | 22.90 % SC | | | | | | | | |
| T 5 | Abamectin | 1 ml | 18.64 | 7.98 | 55.67 | 5.36 | 78.37 | 232 | 9.48 |
| | 1.9% EC | | | | | | | | |
| T 6 | Hexathiazox | 1 ml | 11.04 | 4.16 | 76.89 | 4.79 | 80.67 | 228 | 7.89 |
| | 5.45% EC | | | | | | | | |
| T 7 | Cyenopyrafen | 0.6 ml | 14.09 | 7.00 | 61.11 | 3.89 | 84.30 | 242 | 13.22 |
| | 30% SC | | | | | | | | |
| T 8 | Fluxametamide | 0.8 ml | 13.96 | 6.00 | 66.67 | 4.57 | 81.56 | 229 | 8.30 |
| | 10% EC | | | | | | | | |
| T 9 | Fenpropathrin | 0.5 ml | 12.72 | 5.00 | 72.22 | 5.54 | 77.64 | 231 | 9.09 |
| | 30% EC | | | | | | | | |
| T 10 | Propargite | 1 ml | 15.16 | 6.00 | 66.67 | 3.56 | 85.63 | 244 | 13.93 |
| | 57% EC | | | | | | | | |
| T 11 | Fenazaquin | 2 ml | 16.30 | 7.00 | 61.11 | 5.46 | 77.97 | 237 | 11.39 |
| | 10% EC | | | | | | | | |
| T 12 | Control | — | 13.26 | 18.00 | — | 24.78 | — | 210 | — |

| | | | | | | | | |
|---|---|---|---|---|---|---|---|---|
| SE ± | — | 1.93 | 2.16 | — | 1.98 | — | 2.22 | — |
| C.D. (0.05) | — | N. S. | 6.32 | — | 5.89 | — | 6.62 | — |

### CONCLUSION

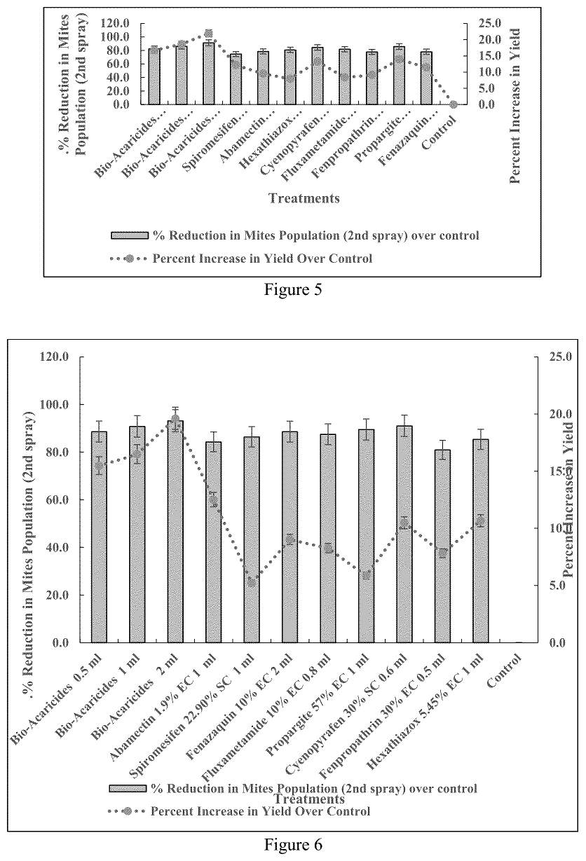

The results of the trial revealed that an application of Bio-acaricide @ 2 ml/l recorded the maximum reduction in Red Mite population of 84.67% over the control in 1^{st} spray and 91.20% reduction in Red Mite population after 2^{nd} spray over the control (FIG. 5).

The bio stimulant effect of Bio-acaricide with an application of 2 ml/l in Rose exhibited the highest increase of 21.93% in yield over the control.

### Example 14: Bio-Efficacy of Bio-Acaricide Against Red Mites in Tomato

Name of the Product: Bio-acaricide Variety: Alankar
Crop: Tomato Pest: Red Mites (Tetranichus spp.)

### Material and Method

A field experiment to study bio efficacy of Bio-acaricide in Tomato was conducted at Kay-Bee Bio-Organics Pvt. Ltd.'s farm at Phaltan, District Satara (M. S.), India, during 2021-2022. The trial consisting of twelve treatments including untreated control was laid out in a Randomized Block Design with three replications. Tomato cultivated on following the standard spacing's 90 cm×30 cm to raise the good crop. Standard cultural practices were followed to grow a good crop. Observations on mite population were recorded by randomly selected five plants in each treatment. Three leaves/plant each from top, middle and bottom canopies were labelled to record mite population using hand lens. The data were analyzed by using standard statistical methods. Two sprays were taken pest population was recorded as per standard method in use before and after the application of Bio-acaricide. The data were calculated by using standard statistical methods.

$$Reduction over control ( \% ) = \frac{\begin{matrix}Population Count of Control Plot - \\ Population Count of Treated Plot\end{matrix}}{Population Count of Control Plot} * 100$$

TABLE 16

| | | | | No. of |
|---|---|---|---|---|
| | | | | Mites |
| | | | | before |
| Tr. No. | Treatments | Dose ml or gm/L | | spray |
| T 1 | Bio-acaricide | 0.5 | ml | 18.16 |
| T 2 | Bio-acaricide | 1 | ml | 21.32 |
| T 3 | Bio-acaricide | 2 | ml | 17.85 |
| T 4 | Abamectin 1.9% EC | 1 | ml | 25.27 |
| T 5 | Spiromesifen 22.90% SC | 1 | ml | 26.76 |
| T 6 | Fenazaquin 10% EC | 2 | ml | 16.62 |
| T 7 | Fluxametamide 10% EC | 0.8 | ml | 23.84 |
| T 8 | Propargite 57% EC | 1 | ml | 21.56 |
| T 9 | Cyenopyrafen 30% SC | 0.6 | ml | 24.72 |
| T 10 | Fenpropathrin 30% EC | 0.5 | ml | 18.62 |
| T 11 | Hexathiazox 5.45% EC | 1 | ml | 19.36 |

| | | | |
|---|---|---|---|
| T 12 | Control | — | 23.16 |

Results: The results are depicted in Table 17.

TABLE 17

| | | | | 1^{st} spray | | 2^{nd} spray | | | |
|---|---|---|---|---|---|---|---|---|---|
| | | | | | % | | % | | |
| | | | | | Reduction | | Reduction | | |
| | | | | | in Mites | No. | in Mites | | % |
| | | | | | Population | of | Population | | Increase |
| | | | No. of | No. of | (1st | Mites | (2nd | | in |
| | | Dose | Mites | Mites | spray) | after | spray) | | Yield |
| Tr. | | ml or | before | after 1st | over | 2nd | over | Yield | over |
| No. | Treatments | gm/L | spray | spray | control | spray | control | (t/ha) | control |
| T 1 | Bio-acaricide | 0.5 ml | 18.16 | 6.16 | 83.79 | 5.27 | 88.54 | 46.56 | 15.46 |
| T 2 | Bio-acaricide | 1 ml | 21.32 | 5.36 | 85.89 | 4.26 | 90.74 | 47.12 | 16.47 |
| T 3 | Bio-acaricide | 2 ml | 17.85 | 4.15 | 89.08 | 3.17 | 93.11 | 48.96 | 19.61 |
| T 4 | Abamectin | 1 ml | 25.27 | 9.36 | 75.37 | 7.24 | 84.26 | 44.98 | 12.49 |
| | 1.9% EC | | | | | | | | |
| T 5 | Spiromesifen | 1 ml | 26.76 | 8.16 | 78.53 | 6.28 | 86.35 | 41.52 | 5.20 |
| | 22.90 % SC | | | | | | | | |
| T 6 | Fenazaquin | 2 ml | 16.62 | 10.11 | 73.39 | 5.28 | 88.52 | 43.26 | 9.02 |
| | 10% EC | | | | | | | | |
| T 7 | Fluxametamide | 0.8 ml | 23.84 | 8.76 | 76.95 | 5.78 | 87.43 | 42.9 | 8.25 |
| | 10% EC | | | | | | | | |
| T 8 | Propargite | 1 ml | 21.56 | 9.54 | 74.89 | 4.87 | 89.41 | 41.8 | 5.84 |
| | 57% EC | | | | | | | | |
| T 9 | Cyenopyrafen | 0.6 ml | 24.72 | 7.56 | 80.11 | 4.15 | 90.98 | 43.96 | 10.46 |
| | 30% SC | | | | | | | | |
| T 10 | Fenpropathrin | 0.5 ml | 18.62 | 9.26 | 75.63 | 8.79 | 80.89 | 42.69 | 7.80 |
| | 30% EC | | | | | | | | |
| T 11 | Hexathiazox | 1 ml | 19.36 | 10.23 | 73.08 | 6.76 | 85.30 | 44.05 | 10.65 |
| | 5.45% EC | | | | | | | | |
| T 12 | Control | | 23.16 | 38.00 | | 46.00 | | 39.36 | |

| | | | | |
|---|---|---|---|---|
| SE ± | 1.89 | 2.23 | 1.93 | 1.56 |
| C.D. (0.05) | N.S. | 6.32 | 5.72 | 4.87 |

### CONCLUSION

The results of the trial revealed that an application of Bio-acaricide @ 2 ml/l recorded the maximum reduction in Red Mite population of 89.08% over the control in 15 spray and 93.11% reduction in Red Mite population after 2^{nd} spray over the control (FIG. 6). The bio stimulant effect of Bio-acaricide with an application of 2 ml/l in Tomato exhibited the highest increase of 19.61% in yield over the control.

### Example 15: In Vitro Bio-Efficacy of Bio-Acaricide Against Red Mite in Citrus

Name of the Product: Bio-acaricide Insect: Red Mite
Crop: Citrus Scientific Name: Panonychus citri

### Material:

1. Specified Insect: Collected citrus nymphal stage red mite culture from insectary section.
2. Host plant leaves: Citrus leaf is used for mite feeding.
3. Spray gun: Required for Spraying pesticides in control condition.
4. Solution for spray: 1 lit spray solution of respective pesticides was prepared.
5. Micropipette: Require for taking accurate volume of pesticide as per recommendations.
6. Microscope: Zoom stereo trinocular microscope for insect observation.

Following treatments was used for experiment:

TABLE 18

| Treatments No. | Treatments | Dose ml or gm/L | |
|---|---|---|---|
| T 1 | Bio-acaricide | 0.5 | ml |
| T 2 | Bio-acaricide | 1 | ml |
| T 3 | Bio-acaricide | 1.5 | ml |
| T 4 | Fluxametamide 10% EC | 0.8 | ml |
| T 5 | Spiromesifen 22.90% SC | 1 | ml |
| T 6 | Propargite 57% EC | 1 | ml |
| T 7 | Fenpropathrin 30% EC | 0.5 | ml |
| T 8 | Hexathiazox 5.45% EC | 1 | ml |
| T 9 | Cyenopyrafen 30% SC | 0.6 | ml |
| T 10 | Abamectin 1.9% EC | 1 | ml |
| T 11 | Fenazaquin 10% EC | 2 | ml |

| | | |
|---|---|---|
| T 12 | Control | — |

### Method:—

### Direct Spray Method

Clean small citrus leaf was placed in a petri plate. 10 red mites per leaf per petri plate released which were taken from insect rearing unit. 12 treatments against 6 replications were maintained in experiment. Pesticide solution was prepared for 1 lit volume by using their respective recommended dosages ideal volume of pesticide per Petri plate was sprayed by using spray gun in control condition. Observations for mortality were taken at 24 hrs and 48 hrs. After spray by using zoom stereoscope microscope. Calculation was done by standard statistical design CRD. Percent Corrected mortality was calculated by following Abbott formula:

$$\% Corrected Mortality = ( \% test mortality - \% control mortality / 100 - control mortality \times 100 ) .$$

Results: The results are shown in Table 19

TABLE 19

| | | | | Total no of | | % Corrected |
|---|---|---|---|---|---|---|
| Treatments | | Dose ml | | dead insects | % Mortality | Mortality at |
| No. | Treatments | or gm/L | | at 48 hrs | at 48 hrs | 48 hrs |
| T 1 | Bio-acaricide | 0.5 | ml | 48 | 80.00 | 78.18 |
| T 2 | Bio-acaricide | 1 | ml | 53 | 88.33 | 87.27 |
| T 3 | Bio-acaricide | 1.5 | ml | 57 | 95.00 | 94.55 |
| T 4 | Fluxametamide | 0.8 | ml | 51 | 85.00 | 83.64 |
| | 10% EC | | | | | |
| T 5 | Spiromesifen | 1 | ml | 45 | 75.00 | 72.73 |
| | 22.90% SC | | | | | |
| T 6 | Propargite 57% | 1 | ml | 42 | 70.00 | 67.27 |
| | EC | | | | | |
| T 7 | Fenpropathrin | 0.5 | ml | 49 | 81.67 | 80.00 |
| | 30% EC | | | | | |
| T 8 | Hexathiazox | 1 | ml | 49 | 81.67 | 80.00 |
| | 5.45% EC | | | | | |
| T 9 | Cyenopyrafen | 0.6 | ml | 52 | 86.67 | 85.45 |
| | 30% SC | | | | | |
| T 10 | Abamectin 1.9% | 1 | ml | 51 | 85.00 | 83.64 |
| | EC | | | | | |
| T 11 | Fenazaquin 10% | 2 | ml | 50 | 83.33 | 81.82 |
| | EC | | | | | |
| T 12 | Control | — | | 5 | 8.33 | 0.00 |
| SE± | | | | 0.62 | | |
| C.D. (0.05) | | | | 1.66 | | |

### CONCLUSION

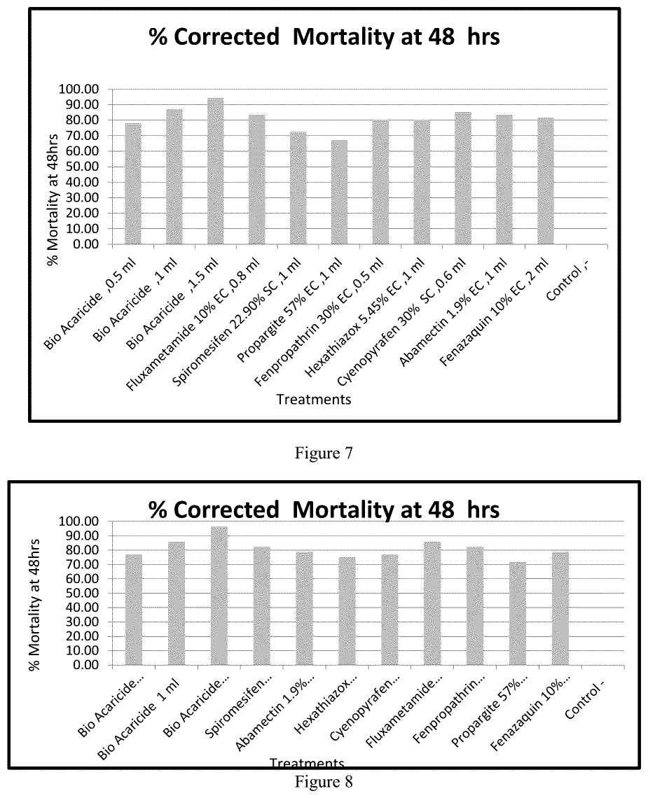

In vitro bio-efficacy study revealed that Bio-acaricide @ 1.5 ml/lit showed highest mortality percentage 94.55% at 48 hours followed by Bio-acaricide @ 1 ml/lit showed 87.27% against citrus red mite (FIG. 7).

### Example 16: In Vitro Bio-Efficacy of Bio-Acaricide Against Red Mite in Rose

Name of the Product: Bio-acaricide Insect: Red Mite
Crop: Rose Scientific Name: Tetranychus cinnabarinus

### Material:

1. Specified Insect Collected rose nymphal stage red mie culture from insectary section
2. Host plant leaves: Rose leaf is used for mite feeding.
3. Spray gun: Required for Spraying pesticides in control condition.
4. Solution for spray: 1 lit spray solution of respective pesticides was prepared.
5. Micropipette: Require for taking accurate volume of pesticide as per recommendations.
6. Microscope: Zoom stereo trinocular microscope for insect observation.

Following treatments was used for experiment:

TABLE 20

| Treatments No. | Treatments | Dose ml or gm/L | |
|---|---|---|---|
| T 1 | Bio-acaricide | 0.5 | ml |
| T 2 | Bio-acaricide | 1 | ml |
| T 3 | Bio-acaricide | 1.5 | ml |
| T 4 | Spiromesifen 22.90% SC | 1 | ml |
| T 5 | Abamectin 1.9% EC | 1 | ml |
| T 6 | Hexathiazox 5.45% EC | 1 | ml |
| T 7 | Cyenopyrafen 30% SC | 0.6 | ml |
| T 8 | Fluxametamide 10% EC | 0.8 | ml |
| T 9 | Fenpropathrin 30% EC | 0.5 | ml |
| T 10 | Propargite 57% EC | 1 | ml |
| T 11 | Fenazaquin 10% EC | 2 | ml |

| | | |
|---|---|---|
| T 12 | Control | — |

### Method:—

### Direct Spray Method

Clean small rose leaf was placed in a petri plate. 10 red mites per leaf per petri plate released which were taken from insect rearing unit. 12 treatments against 6 replications were maintained in experiment. Pesticide solution was prepared for 1 lit volume by using their respective recommended dosages ideal volume of pesticide per Petri plate was sprayed by using spray gun in control condition. Observations for mortality were taken at 24 hrs and 48 hrs. After spray by using zoom stereoscope microscope. Calculation was done by standard statistical design CRD. Percent Corrected mortality was calculated by following Abbott formula:

$$\% Corrected Mortality = ( \% test mortality - \% control mortality / 100 - control mortality \times 100 ) .$$

Results: The results are shown in Table 21

TABLE 21

| | | | | | | % |
|---|---|---|---|---|---|---|
| | | Dose | | Total no of | % | Corrected |
| Treatments | | ml or | | dead insects at | Mortality at | Mortality at |
| No. | Treatments | gm/L | | 48 hrs | 48 hrs | 48 hrs |
| T 1 | Bio-acaricide | 0.5 | ml | 47 | 78.33 | 77.19 |
| T 2 | Bio-acaricide | 1 | ml | 52 | 86.67 | 85.96 |
| T 3 | Bio-acaricide | 1.5 | ml | 58 | 96.67 | 96.49 |
| T 4 | Spiromesifen | 1 | ml | 50 | 83.33 | 82.46 |
| | 22.90% SC | | | | | |
| T 5 | Abamectin | 1 | ml | 48 | 80.00 | 78.95 |
| | 1.9% EC | | | | | |
| T 6 | Hexathiazox | 1 | ml | 46 | 76.67 | 75.44 |
| | 5.45% EC | | | | | |
| T 7 | Cyenopyrafen | 0.6 | ml | 47 | 78.33 | 77.19 |
| | 30% SC | | | | | |
| T 8 | Fluxametamide | 0.8 | ml | 52 | 86.67 | 85.96 |
| | 10% EC | | | | | |
| T 9 | Fenpropathrin | 0.5 | ml | 50 | 83.33 | 82.46 |
| | 30% EC | | | | | |
| T 10 | Propargite | 1 | ml | 44 | 73.33 | 71.93 |
| | 57% EC | | | | | |
| T 11 | Fenazaquin | 2 | ml | 48 | 80.00 | 78.95 |
| | 10% EC | | | | | |

| | | | | | |
|---|---|---|---|---|---|
| T 12 | Control | — | 3 | 5.00 | 0.00 |

| | |
|---|---|
| SE± | 0.56 |
| C.D. (0.05) | 1.48 |

### CONCLUSION

Invitro bio-efficacy study revealed that Bio-acaricide @ 1.5 ml/lit showed highest mortality percentage 96.49% at 48 hours followed by Bio-acaricide @ 1 ml/lit showed 85.96% against rose red mite (FIG. 8).

### Example 17: In Vitro Bio-Efficacy of Bio-Acaricide Against Red Mite in Tomato

Name of the Product: R-Mite Insect: Red Mite
Crop: Tomato Scientific Name: Tetranychus evansi

### Material:

1. Specified Insect: Collected tomato nymphal stage red mite culture from insectary section
2. Host plant leaves: Tomato leaf is used for mite feeding.
3. Spray gun: Required for Spraying pesticides in control condition.
4. Solution for spray: 1 lit spray solution of respective pesticides was prepared.
5. Micropipette: Require for taking accurate volume of pesticide as per recommendations.
6. Microscope: Zoom stereo trinocular microscope for insect observation.

Following treatments was used for experiment:

TABLE 22

| Treatments No. | Treatments | Dose ml or gm/L | |
|---|---|---|---|
| T 1 | Bio-acaricide | 0.5 | ml |
| T 2 | Bio-acaricide | 1 | ml |
| T 3 | Bio-acaricide | 1.5 | ml |
| T 4 | Abamectin 1.9% EC | 1 | ml |
| T 5 | Spiromesifen 22.90% SC | 1 | ml |
| T 6 | Fenazaquin 10% EC | 2 | ml |
| T 7 | Fluxametamide 10% EC | 0.8 | ml |
| T 8 | Propargite 57% EC | 1 | ml |
| T 9 | Cyenopyrafen 30% SC | 0.6 | ml |
| T 10 | Fenpropathrin 30% EC | 0.5 | ml |
| T 11 | Hexathiazox 5.45% EC | 1 | ml |

| | | |
|---|---|---|
| T 12 | Control | — |

### Method:—

### Direct Spray Method

Clean small tomato leaf was placed in a petri plate. 10 red mites per leaf per petri plate released which were taken from insect rearing unit. 12 treatments against 6 replications were maintained in experiment. Pesticide solution was prepared for 1 lit volume by using their respective recommended dosages ideal volume of pesticide per Petri plate was sprayed by using spray gun in control condition. Observations for mortality were taken at 24 hrs and 48 hrs. After spray by using zoom stereoscope microscope. Calculation was done by standard statistical design CRD. Percent Corrected mortality was calculated by following Abbott formula:

% Corrected Mortality=(% test mortality−% control mortality/100−control mortality×100).

Results: The results are shown in Table 23

TABLE 23

| | | | | Total no of | | % Corrected |
|---|---|---|---|---|---|---|
| Treatments | | Dose ml | | dead insects | % Mortality at | Mortality at 48 |
| No. | Treatments | or gm/L | | at48 hrs | 48 hrs | hrs |
| T 1 | Bio-acaricide | 0.5 | ml | 47 | 78.33 | 75.93 |
| T 2 | Bio-acaricide | 1 | ml | 52 | 86.67 | 85.19 |
| T 3 | Bio-acaricide | 1.5 | ml | 59 | 98.33 | 98.15 |
| T 4 | Abamectin | 1 | ml | 54 | 90.00 | 88.89 |
| | 1.9% EC | | | | | |
| T 5 | Spiromesifen | 1 | ml | 48 | 80.00 | 77.78 |
| | 22.90% SC | | | | | |
| T 6 | Fenazaquin | 2 | ml | 40 | 66.67 | 62.96 |
| | 10% EC | | | | | |
| T 7 | Fluxametamide | 0.8 | ml | 48 | 80.00 | 77.78 |
| | 10% EC | | | | | |
| T 8 | Propargite 57% | 1 | ml | 46 | 76.67 | 74.07 |
| | EC | | | | | |
| T 9 | Cyenopyrafen | 0.6 | ml | 51 | 85.00 | 83.33 |
| | 30% SC | | | | | |
| T 10 | Fenpropathrin | 0.5 | ml | 50 | 83.33 | 81.48 |
| | 30% EC | | | | | |
| T 11 | Hexathiazox | 1 | ml | 53 | 88.33 | 87.04 |
| | 5.45% EC | | | | | |
| T 12 | Control | — | | 6 | 10.00 | 0.00 |
| | SE± | | | 0.49 | | |
| | C.D. (0.05) | | | 1.07 | | |

### CONCLUSION

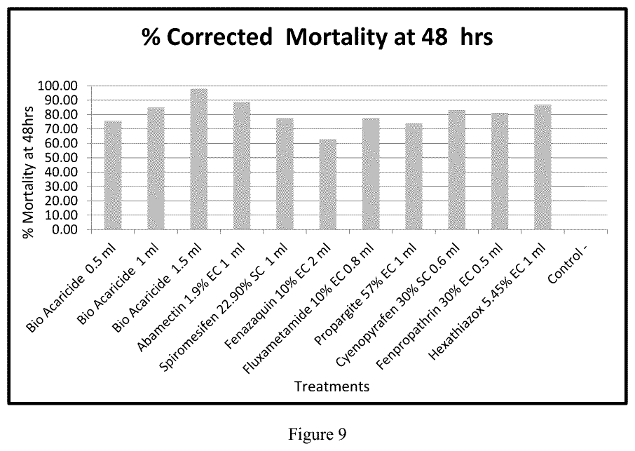

Invitro bio-efficacy study revealed that Bio-acaricide @ 1.5 ml/lit showed highest mortality percentage 98.15% at 48 hours followed by Bio-acaricide @ 1 ml/lit showed 85.19% against tomato red mite (FIG. 9).

1. A synergistic botanical based bio-stimulant, bio-acaricidal composition for controlling pests, comprising:
i. Cinnamomum cassia extract or Enriched and Purified extract of Cinnamomum cassia or Purified Phyto ingredients or marker compounds such as Cinnamic aldehyde, catechin, epicatechin, quercitrin, protocatechuic acid and cinnamic acid extracted from said botanical source at a concentration in a range of 0.001-35%, more preferably 0.001-15%;
ii. Piper nigrum extract or Enriched and Purified extract of Piper nigrum or Purified Phyto ingredients or marker compounds) Piperine, amides, piperidine and pyrrolidines extracted from said botanical source at a concentration in a range of 0.001-35%, more preferably 0.001-10%;
iii. Syzygium aromaticum extract or Enriched and Purified extract of Syzygium aromaticum or Purified Phyto ingredients or marker compounds such as Eugenyl acetate, eugenol, and β-caryophyllene extracted from said botanical source at a concentration in a range of 0.001-45%, more preferably 0.001-8%;
iv. Allium sativum extract or enriched and purified extract of Allium sativum or Purified Phyto ingredients or marker compounds such as alliin, allicin and quercetin extracted from said botanical source at a concentration in a range of 0.001-45%, more preferably 0.05-13%;
v. Zingiber officinale extract or Enriched and Purified extract of Zingiber officinale or Purified Phyto ingredients or marker compounds such as gingerols, shogaols, and paradols extracted from said botanical source at a concentration in a range of 0.001-45%; more preferably 0.1-15%;
vi. Pongamia pinnata extract or Enriched and Purified extract of Pongamia pinnata or Purified Phyto ingredients or marker compounds such as karanjin, glabrin, and kanjone extracted from said botanical source at a concentration in a range of 0.001-45%, more preferably 2-20%;
vii. Anethum graveolens extract or Enriched and Purified extract of Anethum graveolens or Purified Phyto ingredients or marker compounds such as alkaloids, flavonoids, tannins and saponins extracted from said botanical source at a concentration in a range of 0.001-45%, more preferably 2.5-20%;
viii. Citrus sinensis extract or Enriched and Purified extract of Citrus sinensis or Purified Phyto ingredients or marker compounds such as limonene, γ-terpinene, β-pinene, linalool, sabinene, myrcene, α-terpineol, and α-pinene extracted from said botanical source at a concentration in a range of 0.001-45%, more preferably 1.5-10%;
ix. Melaleuca alternifolia extract or Enriched and Purified extract of Melaleuca alternifolia or Purified Phyto ingredients or marker compounds such as terpinen-4-ol, γ-terpinene, α-terpinene, α-pinene, 1,8 cineole and linalool extracted from said botanical source at a concentration in a range of 0.001-45%, more preferably 1.5-10%;
x. Cinnamomum camphora extract or Enriched and Purified extract of Cinnamomum camphora or Purified Phyto ingredients or marker compounds such as linalool, 1,8-cineole, α-terpineol, and camphor extracted from said botanical source at a concentration in a range of 0.001-45%, more preferably 0.05-15%;
xi. Ricinus communis extract or Enriched and Purified extract of Ricinus communis or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source at a concentration in a range of 0.001-45%, more preferably 2.5-20%;
xii. Sesamum indica extract or Enriched and Purified extract of Sesamum indica or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source at a concentration in a range of 0.001-55%, more preferably 15-40%;
xiii. Brassica napus extract or Enriched and Purified extract of Brassica napus or Purified Phyto ingredients or marker compounds such as polyphenols, phenolic acids, flavonoids, carotenoids (zeaxanthin, lutein, β-carotene), brassinolides, alkaloids, tannins and saponins extracted from said botanical source at a concentration in a range of 0.001-55%, more preferably 1-12%;
xiv. Parthenium hysterophorus extract or Enriched and Purified extract of Parthenium hysterophorus or Purified Phyto ingredients or marker compounds such as sesquiterpene lactones, parthenin, quercelagetin, p-hydroxybenzene, chlorogenic acids and ferulic acids extracted from said botanical source at a concentration in a range of 0.001-55%, more preferably 1-15%;
xv. Rosmarinus officinalis extract or Enriched and Purified extract of Rosmarinus officinalis or Purified Phyto ingredients or marker compounds such as sesquiterpene lactones, parthenin, quercelagetin, p-hydroxybenzene, chlorogenic acids and ferulic acids extracted from said botanical source at a concentration in a range of 0.001-55%, more preferably 1.5-20%;
xvi. Acacia concinna extract or Enriched and Purified extract of Acacia concinna or Purified Phyto ingredients or marker compounds such as lupeol, spinasterol, acacic acid, lactone and natural sugars glucose extracted from said botanical source at a concentration in a range of 0.001-55%, more preferably 3-25%;
xvii. Mentha piperita extract or Enriched and Purified extract of Mentha piperita or Purified Phyto ingredients or marker compounds such as lupeol, spinasterol, acacic acid, lactone and natural sugars glucose extracted from said botanical source at a concentration in a range of 0.001-55%, more preferably 0.5-12%;
xviii. Acorus calamus extract or Enriched and Purified extract of Acorus calamus or Purified Phyto ingredients or marker compounds such as lupeol, spinasterol, acacic acid, lactone and natural sugars glucose extracted from said botanical source at a concentration in a range of 0.001-45%, more preferably 3.5-27%;
xix. Ocimum sanctum extract or Enriched and Purified extract of Ocimum sanctum or Purified Phyto ingredients or marker compounds such as oleanolic acid, rosmarinic acid, ursolic acid, eugenol, methyl eugenol, linalool, carvacrol, β elemene and β caryophyllene extracted from said botanical source at a concentration in a range of 0.001-55%, more preferably 0.5-12%;
xx. Lantana camara extract or Enriched and Purified extract of Lantana camara or Purified Phyto ingredients or marker compounds such as tannin, saponin, flavonoids, terpenoids, alkaloids, carbohydrate, anthroquinone and polyphenols extracted from said botanical source at a concentration in a range of 0.001-55%, more preferably 0.5-12%;
xxi. Piper longum extract or Enriched and Purified extract of Piper longum or Purified Phyto ingredients or marker compounds such as methyl piperine, Piperine piperlongumine, piperlonguminine, pipercide and piperidine extracted from said botanical source at a concentration in a range of 0.001-45%, more preferably 0.01-10%;
xxii. Annona squamosa extract or Enriched and Purified extract of Annona squamosa or Purified Phyto ingredients or marker compounds such as Annonacin, Squamocin, Annonin extracted from said botanical source at a concentration in a range of 0.001-45%, more preferably 0.01-12%;
xxiii. Azadirachta indica extract or Enriched and Purified extract of Azadirachta indica or Purified Phyto ingredients or marker compounds such as Annonacin, Squamocin, Annonin extracted from said botanical source at a concentration in a range of 0.001-45%, more preferably 1-15%;
xxiv. Cuminum cyminum extract or Enriched and Purified extract of Cuminum cyminum or Purified Phyto ingredients or marker compounds such as Cumin aldehyde, alkaloid, anthraquinone, saponin, tannin and steroid extracted from said botanical source at a concentration in a range of 0.001-45%, more preferably 1-12%;
xxv. organic emulsifier at a concentration in the range of 0.001-20%;
xxvi. anionic emulsifier at a concentration in the range of 0.001-18%;
xxvii. non-anionic emulsifiers at a concentration in the range of 0.001-20%; and
xxviii. carrier oils at a concentration in the range of 0.001-90%.

2. The synergistic composition, as claimed in claim 1, wherein said composition may comprise an adjuvant at a concentration in the range of 0.001-25%.

3. The synergistic composition, as claimed in claim 2, wherein said adjuvant is at a concentration in the range of 10-20%.

4. The synergistic composition, as claimed in claim 1, wherein said organic emulsifier is at a concentration in the range of 10-12%.

5. The synergistic composition, as claimed in claim 1, wherein said anionic emulsifier is at a concentration in the range of 7-10%.

6. The synergistic composition, as claimed in claim 1, wherein said non-ionic emulsifiers is at a concentration in the range of 12-15%.

7. The synergistic composition, as claimed in claim 1, wherein said carrier oils is at a concentration in the range of 60-65%.

8. The synergistic composition, as claimed in claim 1, wherein said adjuvants are selected from one or more silicone polyether, amine surfactant or amine surfactant ingredient, lecithin or lecithin, polyethylene oxide, polyethylene and the like.

9. The synergistic composition, as claimed in claim 8, wherein said adjuvants are selected from Silicone polyether and amine surfactant.

10. The synergistic composition, as claimed in claim 1, wherein said organic emulsifier is selected from group consisting of rice bran wax, cetearyl glucoside, Aloe vera extract, plant saponins, aqueous extract of Indian soapberry (Sapindus mukorassi), aqueous extract of Acacia concinna, hydrolyzed coconut oil, bee wax, gaur gum and the like.

11. The synergistic composition, as claimed in claim 1, wherein said anionic and non-anionic emulsifier are selected from the group consisting of poly sorbate 20, poly sorbate 60, poly sorbate 80, Lecithin, soy lecithin, sodium phosphates, monoglycerides, diglycerides, sodium stearoyl lactylate, glyceryl oleate, ethoxylated oleate, ethoxylated soybean oil, ethoxylated castor oil and the like.

12. The synergistic composition, as claimed in claim 1, wherein said carrier oils are selected from the group consisting of seed oil of Anethum graveolens, Pongamaia pinnata oil, neem oil, castor oil, fish oil, sesame oil, mustard oil, canola oil, and the like.

13. The synergistic composition, as claimed in claim 1, wherein said composition has a particle size in the range of 10-1000 nanometer.

14. The synergistic composition, as claimed in claim 13, wherein said composition has a particle size in the range of 1-100 nanometer.

15. The synergistic composition, as claimed in claim 1, wherein said composition comprises combination of standardised enriched botanical extract and purified phyto ingredient.

16. The synergistic composition, as claimed in claim 1, wherein said composition consists of enriched and purified Phyto ingredients such as saponins, polyphenols, alkaloids, flavonoids, terpenoids, or secondary metabolites from botanicals.

17. The synergistic composition, as claimed in claim 1, wherein said composition comprises:
i. Brassica napus extract in the range of 0.001 to 35%;
ii. Piper nigrum extract in the range of 0.001 to 35%;
iii. Allium sativum extract in the range of 0.001 to 40%;
iv. Adjuvant extract in the range of 0.001 to 25%;
v. Acorus calamus extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%.

18. The synergistic composition, as claimed in claim 1, wherein said composition comprises:
i. Lantana camara extract in the range of 0.001 to 35%;
ii. Piper nigrum extract in the range of 0.001 to 35%;
iii. Cinnamomum camphora extract in the range of 0.001 to 40%;
iv. Piper longum extract in the range of 0.001 to 25%;
v. Ocimum santum extract in the range of 0.001 to 35%;
vi. Citrus sinensis extract in the range of 0.001 to 25%;
vii. Gaur gum in the range of 0.001 to 18%;
viii. ethoxylated castor oil in the range of 0.001 to 20%; and
ix. Sesame oil in the range of 0.001 to 90%.

19. The synergistic composition, as claimed in claim 1, wherein said composition comprises:
i. Cinnamomum cassia extract in the range of 0.001 to 35%;
ii. Piper nigrum extract in the range of 0.001 to 35%;
iii. Allium sativum extract in the range of 0.001 to 40%;
iv. Ocimum sanctum extract in the range of 0.001 to 25%;
v. Syzygium aromaticum extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%.

20. The synergistic composition, as claimed in claim 1, wherein said composition comprises:
i. Rosmarinus officinalis extract in the range of 0.001 to 35%;
ii. Lantana camara extract in the range of 0.001 to 35%;
iii. Annona squamosa extract in the range of 0.001 to 40%;
iv. Azadirachta indica extract in the range of 0.001 to 25%;
v. Pongamia pinnata extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%.

21. The synergistic composition, as claimed in claim 1, wherein said composition comprises:
i. Syzygium aromaticum extract in the range of 0.001 to 35%;
ii. Piper nigrum extract in the range of 0.001 to 35%;
iii. Allium sativum extract in the range of 0.001 to 40%;
iv. Zingiber officinale extract in the range of 0.001 to 35%;
v. Cinnamomum cassia extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%.

22. The synergistic composition, as claimed in claim 1, wherein said composition comprises:
i. Cinnamomum cassia extract in the range of 0.001 to 35%;
ii. Citrus sinensis extract in the range of 0.001 to 35%;
iii. Allium sativum extract in the range of 0.001 to 40%;
iv. Melaleuca alternifolia extract in the range of 0.001 to 25%;
v. Cuminum cyminum extract in the range of 0.001 to 35%;
vi. Gaur gum in the range of 0.001 to 18%;
vii. ethoxylated castor oil in the range of 0.001 to 20%; and
viii. Canola oil in the range of 0.001 to 90%.

23. A process for preparation of the synergistic botanical based bio-stimulant, bio-acaricidal composition, comprising:
a. Extracting 0.001-35% of Cinnamomum cassia or purified phyto ingredients or marker compounds such as Cinnamic aldehyde, catechin, epicatechin, quercitrin, protocatechuic acid and cinnamic acid extracted from said botanical source; 0.001-35% of Piper nigrum or Purified Phyto ingredients or marker compounds such as Piperine, amides, piperidine and pyrrolidines extracted from said botanical source; 0.001-45% of Syzygium aromaticum or Purified Phyto ingredients or marker compounds such as Eugenyl acetate, eugenol, and β-caryophyllene extracted from said botanical source; 0.001-45% of Allium sativum or Purified Phyto ingredients or marker compounds such as alliin, allicin and quercetin extracted from said botanical source; 0.001-45% of Zingiber officinale or Purified Phyto ingredients or marker compounds such as gingerols, shogaols, and paradols extracted from said botanical source; 0.001-45% of Pongamia pinnata or Purified Phyto ingredients or marker compounds such as karanjin, glabrin, and kanjone extracted from said botanical source; 0.001-45% of Anethum graveolens or Purified Phyto ingredients or marker compounds such as alkaloids, flavonoids, tannins and saponins extracted from said botanical source; 0.001-45% of Citrus sinensis Purified Phyto ingredients or marker compounds such as limonene, γ-terpinene, β-pinene, linalool, sabinene, myrcene, α-terpineol, and α-pinene extracted from said botanical source; 0.001-45% of Melaleuca alternifolia or Purified Phyto ingredients or marker compounds such as terpinen-4-ol, γ-terpinene, α-terpinene, α-pinene, 1,8 cineole and linalool extracted from said botanical source; 0.001-45% of Cinnamomum camphora or Purified Phyto ingredients or marker compounds such as linalool, 1,8-cineole, α-terpineol, and camphor extracted from said botanical source; 0.001-45% of Ricinus communis or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source; 0.001-55% of Sesamum indica or Purified Phyto ingredients or marker compounds such as kaempferol-3-O and lupeol, β- and α-amyrin, quercetin, camphor, ricin, epicatechin, catechin, linoleic acid and ricinoleic acid extracted from said botanical source; 0.001-55% of Brassica napus or Purified Phyto ingredients or marker compounds such as polyphenols, phenolic acids, flavonoids, carotenoids (zeaxanthin, lutein, β-carotene), brassinolides alkaloids, tannins and saponins extracted from said botanical source; 0.001-55% of Parthenium hysterophorus or Purified Phyto ingredients or marker compounds such as sesquiterpene lactones, parthenin, quercelagetin, p-hydroxybenzene, chlorogenic acids and ferulic acids extracted from said botanical source; 0.001-55% of Rosmarinus officinalis or Purified Phyto ingredients or marker compounds such as sesquiterpene lactones, parthenin, quercelagetin, p-hydroxybenzene, chlorogenic acids and ferulic acids extracted from said botanical source; 0.001-55% of Acacia concinna or Purified Phyto ingredients or marker compounds such as lupeol, spinasterol, acacic acid, lactone and natural sugars glucose extracted from said botanical source; 0.001-55% of Mentha piperita or Purified Phyto ingredients or marker compounds such as lupeol, spinasterol, acacic acid, lactone and natural sugars glucose extracted from said botanical source; 0.001-45% of Acorus calamus or Purified Phyto ingredients or marker compounds such as methyl ethers, camphene, P-cymene, α-selinene, bgurjunene, β-cadinene, camphor, shyobunones, linalool and preisocalamendiol extracted from said botanical source; 0.001-55% of Ocimum sanctum or Purified Phyto ingredients or marker compounds such as oleanolic acid, rosmarinic acid, ursolic acid, eugenol, methyl eugenol, linalool, carvacrol, β elemene and β caryophyllene extracted from said botanical source; 0.001-55% of Lantana camara or Purified Phyto ingredients or marker compounds such as tannin, saponin, flavonoids, terpenoids, alkaloids, carbohydrate, anthroquinone and polyphenols extracted from said botanical source; 0.001-45% of Piper longum or Purified Phyto ingredients or marker compounds such as methyl piperine, Piperine piperlongumine, piperlonguminine, pipercide and piperidine extracted from said botanical source; 0.001-45% of Annona squamosa or Purified Phyto ingredients or marker compounds such as Annonacin, Squamocin, Annonin extracted from said botanical source; 0.001-45% of Azadirachta indica or Purified Phyto ingredients or marker compounds such as Annonacin, Squamocin, Annonin extracted from said botanical source; 0.001-45% of Cuminum cyminum or Purified Phyto ingredients or marker compounds such as Cumin aldehyde, alkaloid, anthraquinone, saponin, tannin and steroid extracted from said botanical source;
b. optionally mixing the ingredients of step (a) at given proportion with 10-20% adjuvant;
c. mixing the mixture obtained in step (b) at given proportion along with 0.001-20% of organic emulsifier, 0.01-5% of anionic and 0.01-8% % of non-anionic emulsifiers;
d. blending the mixture obtained in step (c) with 0.001-90% of carrier oils; more specifically 25-75%
e. stirring the mixture obtained in step (d) at 300-1000 RPM more specifically at 350-750 RPM at 25-55° C. in closed mixing vessel for continued stirring followed by homogenizing the mix with the homogenizer fitted towards the bottom of vessel and with the speed of 3700˜27000 rpm to reduce the particle size;
f. passing the homogenized mixture obtained in step (e) through in line shear pump with 1800 RPM to 5800 RPM to reduce particle size to obtain the nano emulsion with particle size ranging from 10 to 1000 nano meter;
g. passing the mixture obtained in step (f) through High-pressure homogenization to reduce the particle size below 100 nano meters;
h. passing the mixture obtained in step (g) through sparkler filter having seven layers of membrane filters with pore size less than 1-2 micron to achieve desired filtration; and
i. recovering the final product.

24. The process as claimed in claim 23, wherein extraction process of step (a) comprises enrichment and purification of the extract using techniques which include but not limited to liquid-liquid extraction based on polarity of phyto ingredient, column chromatography, precipitation and crystallisation to obtain purified phyto ingredients.

25. The process as claimed in claim 23, wherein high-pressure homogenization of step (g) is carried out at a speed of 4000 rpm to 10000 rpm and pressure up to 4,200 bar (60,000 psi).

26. The process as claimed in claim 23, wherein said extraction techniques include but not limited to hydrophilic extraction, super critical carbon dioxide extraction, steam distillation, solvent extraction, Soxhlet extraction and the like.

27. The process as claimed in claim 23, wherein said extraction technique is selected from the group consisting of Solvent extraction, steam distillation and super critical carbon dioxide extraction and the like.

28. The process as claimed in claim 23, wherein said adjuvant are selected from one or more silicone polyether, amine surfactant or amine surfactant ingredient, lecithin or lecithin, polyethylene oxide, polyethylene and the like.

29. The process as claimed in claim 23, wherein said organic emulsifier include but not limited to rice bran wax, cetearyl glucoside, Aloe vera extract, plant saponins, aqueous extract of Indian soapberry (Sapindus mukorassi), aqueous extract of Acacia concinna, hydrolyzed coconut oil, bee wax, gaur gum and the like.

30. The process as claimed in claim 23, wherein said anionic and non-anionic emulsifier include but not limited poly sorbate 20, poly sorbate 60, poly sorbate 80, Lecithin, soy lecithin, sodium phosphates, monoglycerides, diglycerides, sodium stearoyl lactylate, glyceryl oleate, ethoxylated oleate, ethoxylated soybean oil, ethoxylated castor oil and the like.

31. The process as claimed in claim 23, wherein said carrier oils are selected from the group comprising seed oil of Anethum graveolens, Pongamaia pinnata oil, neem oil, castor oil, fish oil, sesame oil, mustard oil, canola oil, water and the like.

32. The process as claimed in claim 23, wherein the solvent used in the solvent extraction includes but not limited to alcohols, hydrocarbons, ketones, esters, ethers, and the like alone or in combination thereof.

33. The process as claimed in claim 23, wherein further purification of Phyto ingredient is carried out by using liquid liquid extraction, various chromatograph techniques like silica gel chromatography, ion exchange chromatography and other purification like precipitation and crystallization.

34. The process as claimed in claim 23, wherein the standardized botanical extract are blended with each other along with more than one and less than five emulsifiers, at temperature ranging from 10° C. to 45° C. and stirring ranging from 50-800 RPM.

35. The synergistic composition, as claimed in claim 1, wherein said composition is effective against agricultural pests such as sucking pests, spiders, ticks, mites including red or yellow mites such as Tetranychus urticae, Tetranychus cinnabarinus, Panonychus ulmi, Panonychus citri and the like.

36. The synergistic composition, as claimed claim 1, wherein said composition is at a concentration ranging between 0.5 to 2.0 ml/L.

37. The synergistic composition, as claimed in claim 1, wherein said composition may be applied by sprinkler application, sprayer application or drip application, more preferably by sprayer application such as foliar sprays, sprays to be applied to plants shoots and the like.

38. The synergistic composition, as claimed in claim 1, wherein said composition is useful for controlling plant pests and improving yield of crop plants.

39. The synergistic composition, as claimed in claim 1, wherein said composition exhibits biostimulant activity and thereby improves plant growth and crop yield.

40. The synergistic composition, as claimed in claim 1, wherein the composition may be in the form of liquid, paste, powder or powder converted into granule or tablet form and the like.

41. The synergistic composition, as claimed in claim 39, wherein the composition may be in liquid form.

42. A method for controlling the pest and promoting the growth of the plants comprising applying the present bio-acaricidal composition to the plant or to diseased affected parts of the plant in an effective amount.
